(19) United States
(12) Patent Application Publication
(10) Pub. No.: US 2003/0123852 A1
(43) Pub. Date: Jul. 3, 2003

(54) Information distribution reproduction system, information distribution method, information reproduction method, information recording method, information distributing apparatus, information reproducing apparatus , information recording apparatus, recording medium, and work apparatus

(76) Inventor: Yorio Takahashi, Ehime (JP)

Correspondence Address: WENDEROTH, LIND & PONACK, L.L.P., 2033 K STREET N. W., SUITE 800, WASHINGTON, DC, 20006-1021, US

(21) Appl. No.: 10/168,569

(22) PCT Filed: Aug. 23, 2001
(86) PCT No.: PCT/JP01/07215

(30) Foreign Application Priority Data
Oct. 23, 2000 (JP) 2000-322897

(51) Int. Cl. H04N 5/783; H04N 7/52

(52) U.S. Cl. 386/69; 386/98

(57) ABSTRACT

A work is advanced according to an instruction of reproduction information with a minimum operation, by automatically stopping the reproduction information at a desired position and resuming it as desired.

Information distributed from an information distribution apparatus includes indexes, the information with the indexes are temporarily recorded on an information recording medium of an information recording/reproduction apparatus, and reproduction of the recorded information is temporarily stopped at a desired position on the basis of the result of detection of an index, and the result of mode selection by the user of the information as to whether reproduction should be temporarily stopped at the detected index. Then, the user of the information resumes reproduction of the information as desired by using an operation switch.

### TECHNICAL FIELD

The present invention relates to an information distribution/reproduction system utilizing an information reproduction apparatus which comprises an information disk reproduction apparatus, such as a VTR, a personal video recorder (a video recording/reproduction apparatus using a hard disk as a recording medium), a video CD or DVD-video recording/reproduction apparatus, or a laser disk player, a semiconductor memory, and the like, as well as a television broadcast, a streaming media broadcast via a bidirectional network, or the like.

### BACKGROUND ART

As apparatuses for reproducing audio and video signals recorded on mediums, there have conventionally been employed a video deck, a digital video deck, and the like using a compact disk (CD), a mini disk (MD), a laser disk, a video CD, a DVD video, or a tape medium, and further, a hard disk video recorder using a hard disk device as a recording medium has also been put to practical use. On the other hand, as methods for distributing information via a radio wave or a cable and reproducing the information, there have been employed a television broadcast reception method and a radio broadcast reception method, and furthermore, a streaming media broadcast, which is requested by users of information utilizing media such as the Internet, has been put to practical use.

FIG. 8 is a block diagram illustrating an information distribution/reproduction system using a DVD video unit and a television unit as apparatuses for reproducing audio and video signals recorded on a medium.

In FIG. 8, reference numeral 801 denotes an information distribution apparatus, 802 denotes an information reproduction apparatus, 803 denotes an information recording apparatus, 804 denotes an operation switch, 805 denotes an information recording/reproduction means, 806 denotes a recording/reproduction control means, 807 denotes a recording medium, 808 denotes an information distribution means, and 809 denotes an information reproduction means.

Next, the operation will be described.

The information distribution apparatus 801 such as a broadcast station distributes video and audio information from various kinds of mediums (VTR, video disk, audio visual information taken at real time, and the like) through an information transfer medium such as a radio wave or an optical fiber cable, and the user of the information receives the information and reproduces video and audio signals by using the information reproduction apparatus 802. Further, in the conventional information recording apparatus 803 such as a VTR, the user of the information temporarily records the video and audio information distributed from the information distribution apparatus 801 on the recording medium 807 such as a tape, reproduces the information by pressing the operation switch 804 of the information recording apparatus 803, and distributes the information to the information reproduction apparatus 802 wherein pictures and sounds are reproduced.

Furthermore, the user of the information temporarily stops the reproduction of the video and audio information by pressing a pause switch or a stop switch which is included in the operation switch 804, at a desired point of the medium 807, and resumes the reproduction of the information by pressing a reproduction start switch.

As described above, in the conventional information distribution/reproduction system, when the user of information temporarily stops or resumes reproduction of information at a desired point using a recording medium such as a tape, the user must operate the information recording apparatus. Further, when the user of information needs to check the reproduced information again, the user must search for a desired portion by performing fast reverse or fast forward of the recording medium to reproduce the information again.

An information distribution/reproduction system according to the present invention can temporarily stop reproduction of information automatically at a position desired by the distributor or user of information, and it can resume reproduction of information automatically at a point of time when the user needs to resume reproduction of information.

### DISCLOSURE OF THE INVENTION

According to the present invention (Claim 1), there is provided an information distribution/reproduction system for distributing and reproducing information such as a moving picture, a still picture, a sound, characters, or the like, wherein information in which indexes indicating paragraphs of the information are inserted is distributed; each index is detected by an index detection means; either a mode of temporarily stopping reproduction of the information at the detected index or a mode of continuing reproduction is selected by a mode selection means; and whether reproduction of the information should be temporarily stopped or continued is controlled by an information reproduction control means, on the basis of the results obtained by the index detection means and the mode selection means.

According to the present invention (Claim 2), there is provided an information distribution/reproduction system for distributing and reproducing information such as a moving picture, a still picture, a sound, characters, or the like, wherein information in which indexes indicating paragraphs of the information are inserted is distributed; the information including the indexes is temporarily recorded on a recording medium by an information recording/reproduction means, and the information recorded on the recording medium is reproduced; each index is detected by an index detection means; either a mode of temporarily stopping reproduction of the information at a detected index or a mode of continuing reproduction is selected by a mode selection means; and whether reproduction of the information recorded on the recording medium should be temporarily stopped or continued is controlled by an information reproduction control means, on the basis of the results obtained by the index detection means and the mode selection means.

According to the present invention (Claim 3), in the information distribution/reproduction system defined in Claim 1, an instruction for resuming reproduction of the information, which reproduction is being temporarily stopped on the basis of the results obtained by the index detection means and the mode selection means, is transmitted to an information distribution apparatus which has distributed the information in which the indexes are inserted.

According to the present invention (Claim 4), in the information distribution/reproduction system defined in Claim 1 or 2, information in which the indexes are not inserted is distributed, and the information is reproduced.

According to the present invention (Claim 5), in the information distribution/reproduction system defined in Claim 4, an information reproduction apparatus, which reproduces the information that includes the indexes and is distributed from the information distribution apparatus, is specified by an information reproduction apparatus specifying means; even when distribution of the information from the distribution apparatus is interrupted, the information is redistributed by a resume means to the information reproduction apparatus to which the information has been distributed; and accounting information according to the information is formed by an accounting information formation means.

According to the present invention (Claim 6), in the information distribution/reproduction system defined in Claim 1 or 2, information, in which an index including data of addresses that indicate the positions of paragraphs in the information is inserted at the beginning of the information, is distributed; the index is detected by the index address detection means; the detected index is stored in an index address storage means; and when the information reaches any of the addresses, a detection signal is outputted by the index address detection means, and the index is inserted and recorded in the address.

According to the present invention (Claim 7), in the information distribution/reproduction system defined in Claim 6, when the information is work information, the index is inserted between a procedure along which the user of the information actually performs the work, and a procedure along which a working apparatus automatically performs the work for a predetermined period of time when the user of the information operates the working apparatus.

According to the present invention (Claim 8), in the information distribution/reproduction system defined in Claim 1 or 2, when the information is work information, the contents of a work corresponding to each of plural blocks into which the information is divided by the indexes are recorded as characters in a position where reproduction of the information is to be temporarily stopped at any of the indexes.

According to the present invention (Claim 9), in the information distribution/reproduction system defined in Claim 8, when reproduction of the information is temporarily stopped at the index, an image in which the contents of a work corresponding to each of plural blocks into which the information is divided by the indexes are recorded as characters, is displayed.

According to the present invention (Claim 10), in the information distribution/reproduction system defined in Claim 7, it is detected by a start-of-work detection means that the working apparatus for performing the work on the basis of the information starts the work.

According to the present invention (Claim 11), in the information distribution/reproduction system defined in Claim 10, the time required for the work is stored in each index by a work time storage means; the information between the indexes is stored as a block by a work block storage means; the remaining time of the time required for the work, in which the working apparatus automatically performs the work for a predetermined period of time, is counted by a timer means; and a work procedure is determined by a work procedure optimization means so that the time required for the work is minimized, according to a total time storage means, the work block storage means, and the timer means.

According to the present invention (Claim 12), in the information distribution/reproduction system defined in Claim 11, at least one of the times stored in the work time storage means is changed by a work time change means.

According to the present invention (Claim 13), in the information distribution/reproduction system defined in Claim 11, the time during which the working apparatus automatically performs the work for a predetermined period is counted by a time counting means from a point of time when distribution of the information, which has been temporarily stopped by the information reproduction control means, is resumed; and a work procedure is determined by the work procedure optimization means so that the time required for the subsequent work becomes shortest, by comparing the remaining work time, the time required for the work to be performed by the worker in the future, and the time required for the work to be performed by the working apparatus.

According to the present invention (Claim 14), in the information distribution/reproduction system defined in Claim 13, the information is information for performing cooking; the work the worker actually performs is a work such as cutting, forming, stirring, mixing, or the like during the cooking; and the work the working apparatus automatically performs is a work such as cooling, heating, or the like.

According to the present invention (Claim 15), there is provided an information distribution method for distributing information such as a moving picture, a still picture, a sound, characters, or the like, wherein information in which indexes indicating paragraphs of the information are inserted is distributed.

According to the present invention (Claim 16), in the information distribution method as defined in Claim 15, information in which the indexes are not inserted is distributed.

According to the present invention (Claim 17), in the information distribution method defined in Claim 16, an information reproduction apparatus, which reproduces the information that includes the indexes and is distributed from an information distribution apparatus, is specified by an information reproduction apparatus specifying means; even when distribution of the information from the distribution apparatus is interrupted, the information is redistributed by a resume means to the information reproduction apparatus to which the information has been distributed; and accounting information according to the information is formed by an accounting information formation means.

According to the present invention (Claim 18), in the information distribution method defined in Claim 17, an index including data of addresses that indicate the positions of paragraphs in the information, which index is inserted at the beginning of the information, is detected by an index address detection means; the detected index is stored in an index address storage means; and when the information reaches any of the addresses, a detection signal is outputted by the index address detection means, and the index is inserted and recorded in the address.

According to the present invention (Claim 19), in the information distribution method defined in Claim 18, the time required for the work is stored in each index by a work time storage means; the information between the indexes is stored as a block by a work block storage means; the remaining time of the time required for the work, in which the working apparatus automatically performs the work for a predetermined period of time, is counted by a timer means; and a work procedure is determined by a work procedure optimization means so that the time required for the work is minimized, according to a total time storage means, the work block storage means, and the timer means.

According to the present invention (Claim 20), in the information distribution method defined in Claim 19, at least one of the times stored in the work time storage means is changed by a work time change means.

According to the present invention (Claim 21), in the information distribution method defined in Claim 20, the time during which the working apparatus automatically performs the work for a predetermined period is counted by a time counting means from a point of time when distribution of the information which has been temporarily stopped by the information reproduction control means is resumed; and a work procedure is determined by the work procedure optimization means so that the time required for the subsequent work is minimized, by comparing the remaining work time, the time required for the work to be performed by the worker in the future, and the time required for the work to be performed by the working apparatus.

According to the present invention (Claim 22), there is provided an information reproduction method for distributing and reproducing information such as a moving picture, a still picture, a sound, characters, or the like, wherein information in which indexes indicating paragraphs of the information are inserted is reproduced.

According to the present invention (Claim 23), in the information reproduction method defined in Claim 22, each index is detected by an index detection means; either a mode of temporarily stopping the reproduction of the information at the detected index or a mode of continuing the reproduction is selected by a mode selection means; and whether the reproduction of the information should be temporarily stopped or continued is controlled by an information reproduction control means, on the basis of the results obtained by the index detection means and the mode selection means.

According to the present invention (Claim 24), in the information reproduction method defined in Claim 23, an instruction for resuming reproduction of the information, which reproduction is being temporarily stopped on the basis of the results obtained by the index detection means and the mode selection means, is distributed to an information distribution apparatus which distributes the information in which the indexes are inserted.

According to the present invention (Claim 25), in the information reproduction method defined in Claim 23, information in which the indexes are not inserted is reproduced.

According to the present invention (Claim 26), in the information reproduction method defined in Claim 25, an information reproduction apparatus, which reproduces the information that includes the indexes and is distributed from the information distribution apparatus, is specified by an information reproduction apparatus specifying means; even when distribution of the information from the distribution apparatus is interrupted, the information is redistributed by a resume means to the information reproduction apparatus to which the information has been distributed; and accounting information according to the information is formed by an accounting information formation means.

According to the present invention (Claim 27), in the information reproduction method defined in Claim 21, an index including data of addresses that indicate the positions of paragraphs in the information, which index is inserted at the beginning of the information, is detected by an index address detection means; the detected index is stored in an index address storage means; and when the information reaches any of the addresses, a detection signal is outputted by the index address detection means, and the index is inserted and recorded in the address.

According to the present invention (Claim 28), in the information reproduction method defined in Claim 23, the information is work information, and an index display means displays an image in which the contents of a work corresponding to each of plural blocks into which the information is divided at the indexes are recorded as characters, when reproduction of the information is temporarily stopped due to the index.

According to the present invention (Claim 29), in the information reproduction method defined in Claim 27, it is detected by a work start detection means that the working apparatus for performing a work on the basis of the information starts the work.

According to the present invention (Claim 30), in the information reproduction method defined in Claim 29, the time required for the work is stored in each index by a work time storage means; the information between the indexes is stored as a block in a work block storage means; the remaining time of the time required for the work, in which the working apparatus automatically performs the work for a predetermined period of time, is counted by a timer means; and a work procedure is determined by a work procedure optimization means so that the time required for the work is minimized, according to a total time storage means, the work block storage means, and the timer means.

According to the present invention (Claim 31), in the information reproduction method defined in Claim 30, at least one of the times stored in the work time storage means is changed by a work time change means.

According to the present invention (Claim 32), in the information reproduction method defined in Claim 31, the time during which the working apparatus automatically performs the work for a predetermined period is counted by a time counting means from a point of time when distribution of the information, which has been temporarily stopped by the information reproduction control means, is resumed; and a work procedure is determined by the work procedure optimization means so that the time required for the subsequent working is minimized, by comparing the remaining work time, the time required for the work to be performed by the worker in the future, and the time required for the work to be performed by the working apparatus.

According to the present invention (Claim 33), there is provided an information recording method for recording information such as a moving picture, a still picture, a sound, characters, or the like, wherein information in which indexes indicating paragraphs of the information are inserted is recorded together with the indexes on a recording medium by an information recording/reproduction means, or the information recorded on the recording medium is reproduced; each index is detected by an index detection means; either a mode of temporarily stopping the reproduction of the information at the detected index or a mode of continuing the reproduction is selected by a mode selection means; and whether the reproduction of the information should be temporarily stopped or continued is controlled by an information reproduction control means, on the basis of the results obtained by the index detection means and the mode selection means.

According to the present invention (Claim 34), in the information recording method defined in Claim 33, the index is detected by the index address detection means; the detected index is stored in an index address storage means; and when the information reaches any of addresses included in the index, a detection signal is outputted by an index address detection means, and the index is inserted and recorded in the address.

According to the present invention (Claim 35), there is provided an information distribution apparatus for distributing information such as a moving picture, a still picture, a sound, characters, or the like, wherein information in which indexes indicating. paragraphs of the information are inserted is distributed.

According to the present invention (Claim 36), in the information distribution apparatus defined in Claim 35, information in which the indexes are not inserted is distributed.

According to the present invention (Claim 37), in the information distribution apparatus defined in Claim 36, an information reproduction apparatus, which reproduces the information that includes the indexes and is distributed from the information distribution apparatus, is specified by an information reproduction apparatus specifying means; even when distribution of the information from the distribution apparatus is interrupted, the information is redistributed by a resume means to the information reproduction apparatus to which the information has been distributed; and accounting information according to the information is formed by an accounting information formation means.

According to the present invention (Claim 38), in the information distribution apparatus defined in Claim 37, an index including data of addresses that indicate the positions of paragraphs in the information, which index is inserted at the beginning of the information, is detected by the index address detection means; the detected index is stored in an index address storage means; and when the information reaches any of the addresses, a detection signal is outputted by the index address detection means, and the index is inserted and recorded in the address.

According to the present invention (Claim 39), in the information distribution apparatus defined in Claim 38, the time required for the work is stored in each index by a work time storage means; the information between the indexes is stored as a block in a work block storage means; the remaining time of the time required for the work, in which the working apparatus automatically performs the work for a predetermined period of time, is counted by a timer means; and a work procedure is determined by a work procedure optimization means so that the time required for the work is minimized, according to a total time storage means, the work block storage means, and the timer means.

According to the present invention (Claim 40), in the information distribution apparatus defined in Claim 39, at least one of the times stored in the work time storage means is changed by a work time change means.

According to the present invention (Claim 41), in the information distribution apparatus defined in Claim 40, the time during which the working apparatus automatically performs the work for a predetermined period is counted by a time counting means from a point of time when distribution of the information which has been temporarily stopped by the information reproduction control means is resumed; and a work procedure is determined by the work procedure optimization means so that the time required for the subsequent work is minimized, by comparing the remaining work time, the time required for the work to be performed by the worker in the future, and the time required for the work to be performed by the working apparatus.

According to the present invention (Claim 42), there is provided an information reproduction apparatus for distributing and reproducing information such as a moving picture, a still picture, a sound, characters, or the like, wherein information in which indexes indicating paragraphs of the information are inserted, is reproduced.

According to the present invention (Claim 43), in the information reproduction apparatus defined in Claim 42, each index is detected by an index detection means; either a mode of temporarily stopping the reproduction of the information at the detected index or a mode of continuing the reproduction is selected by a mode selection means; and whether the reproduction of the information should be temporarily stopped or continued is controlled by an information reproduction control means, on the basis of the results obtained by the index detection means and the mode selection means.

According to the present invention (Claim 44), in the information reproduction apparatus defined in Claim 43, an instruction for resuming reproduction of the information, which reproduction is being temporarily stopped on the basis of the results obtained by the index detection means and the mode selection means, is distributed to an information distribution apparatus which distributes the information in which the indexes are inserted.

According to the present invention (Claim 45), in the information reproduction apparatus defined in Claim 43, information in which the indexes are not inserted is reproduced.

According to the present invention (Claim 46), in the information reproduction apparatus defined in Claim 45, an information reproduction apparatus, which reproduces the information that includes the indexes and is distributed from the information distribution apparatus, is specified by an information reproduction apparatus specifying means; even when distribution of the information from the distribution apparatus is interrupted, the information is redistributed by a resume means to the information reproduction apparatus to which the information has been distributed; and accounting information according to the information is formed by an accounting information formation means.

According to the present invention (Claim 47), in the information reproduction apparatus defined in Claim 43, an index including data of addresses that indicate the positions of paragraphs in the information, which index is inserted at the beginning of the information, is detected by an index address detection means; the detected index is stored in an index address storage means; and when the information reaches any of the addresses, a detection signal is outputted by the index address detection means, and the index is inserted and recorded in the address.

According to the present invention (Claim 48), in the information reproduction apparatus defined in Claim 43, the information is work information, and an index display means displays an image in which the contents of a work corresponding to each of plural blocks into which the information is divided at the indexes are recorded as characters, when reproduction of the information is temporarily stopped due to the index.

According to the present invention (Claim 49), in the information reproduction apparatus defined in Claim 47, it is detected by a work start detection means that the working apparatus for performing a work on the basis of the information starts the work.

According to the present invention (Claim 50), in the information reproduction apparatus defined in Claim 49, the time required for the work is stored in each index by a work time storage means; the information between the indexes is stored as a block in a work block storage means; the remaining time of the time required for the work, in which the working apparatus automatically performs the work for a predetermined period of time, is counted by a timer means; and a work procedure is determined by a work procedure optimization means so that the time required for the work is minimized, according to a total time storage means, the work block storage means, and the timer means.

According to the present invention (Claim 51), in the information reproduction apparatus defined in Claim 50, at least one of the times stored in the work time storage means is changed by a work time change means.

According to the present invention (Claim 52), in the information reproduction apparatus defined in Claim 51, the time during which the working apparatus automatically performs the work for a predetermined period is counted by a time counting means from a point of time when distribution of the information which has been temporarily stopped by the information reproduction control means is resumed; and a work procedure is determined by the work procedure optimization means so that the time required for the subsequent work is minimized, by comparing the remaining work time, the time required for the work to be performed by the worker in the future, and the time required for the work to be performed by the working apparatus.

According to the present invention (Claim 53), there is provided an information recording apparatus for recording information such as a moving picture, a still picture, a sound, characters, or the like, wherein information in which indexes indicating paragraphs of the information are inserted is recorded together with the indexes on a recording medium by an information recording/reproduction means, and the information recorded on the recording medium is reproduced; each index is detected by an index detection means; either a mode of temporarily stopping the reproduction of the information at the detected index or a mode of continuing the reproduction is selected by a mode selection means; and whether the reproduction of the information should be temporarily stopped or continued is controlled by an information reproduction control means, on the basis of the results obtained by the index detection means and the mode selection means.

According to the present invention (Claim 54), in the information recording apparatus defined in Claim 53, the index is detected by the index address detection means; the detected index is stored in an index address storage means; and when the information reaches any of index addresses, a detection signal is outputted by an index address detection means, and the index is inserted and recorded in the address.

According to the present invention (Claim 55), there is provided an information recording medium in which information such as a moving picture, a still picture, a sound, characters, or the like is recorded, wherein information in which indexes indicating paragraphs of the information are inserted is recorded together with the indexes.

According to the present invention (Claim 56), there is provided a working apparatus for performing a work on the basis of information such as a moving picture, a still picture, a sound, characters or the like, wherein an information reproduction apparatus is informed that the working apparatus starts a work on the basis of the information.

According to the present invention (Claim 1), in an information distribution/reproduction system for distributing and reproducing information such as a moving picture, a still picture, a sound, characters, or the like, information in which indexes indicating paragraphs of the information are inserted is distributed; each index is detected by an index detection means; either a mode of temporarily stopping reproduction of the information at the detected index or a mode of continuing reproduction is selected by a mode selection means; and whether reproduction of the information should be temporarily stopped or continued is controlled by an information reproduction control means, on the basis of the results obtained by the index detection means and the mode selection means. Therefore, the system can temporarily stop reproduction of the information automatically at a position desired by the user or distributor of the information.

According to the present invention (Claim 2), in an information distribution/reproduction system for distributing and reproducing information such as a moving picture, a still picture, a sound, characters, or the like, information in which indexes indicating paragraphs of the information are inserted is distributed; the information including the indexes is temporarily recorded on a recording medium by an information recording/reproduction means, and the information recorded on the recording medium is reproduced; each index is detected by an index detection means; either a mode of temporarily stopping reproduction of the information at a detected index or a mode of continuing reproduction is selected by a mode selection means; and whether reproduction of the information recorded on the recording medium should be temporarily stopped or continued is controlled by an information reproduction control means, on the basis of the results obtained by the index detection means and the mode selection means. Therefore, the system can temporarily stop reproduction of the information recorded on the recording medium, automatically, at a position desired by the user or distributor of the information.

According to the present invention (Claim 3), in the information distribution/reproduction system defined in Claim 1, an instruction for resuming reproduction of the information, which reproduction is being temporarily stopped on the basis of the results obtained by the index detection means and the mode selection means, is transmitted to an information distribution apparatus which has distributed the information in which the indexes are inserted. Therefore, the system can resume reproduction of the information, which has temporarily been stopped at a position desired by the user or distributor of the information.

According to the present invention (Claim 4), in the information distribution/reproduction system defined in Claim 1 or 2, information in which the indexes are not inserted is distributed, and the information is reproduced. Therefore, the system can reproduce even the information of the conventional format, in which no indexes are inserted.

According to the present invention (Claim 5), in the information distribution/reproduction system defined in Claim 4, an information reproduction apparatus, which reproduces the information that includes the indexes and is distributed from the information distribution apparatus, is specified by an information reproduction apparatus specifying means; even when distribution of the information from the distribution apparatus is interrupted, the information is redistributed by a resume means to the information reproduction apparatus to which the information has been distributed; and accounting information according to the information is formed by an accounting information formation means. Therefore, the system can distribute the information to a specified information reproduction apparatus, and further, it can calculate the use change of the information.

According to the present invention (Claim 6), in the information distribution/reproduction system defined in Claim 1 or 2, information, in which an index including data of addresses that indicate the positions of paragraphs in the information is inserted at the beginning of the information, is distributed; the index is detected by the index address detection means; the detected index is stored in an index address storage means; and when the information reaches any of the addresses, a detection signal is outputted by the index address detection means, and the index is inserted and recorded in the address. Therefore, the system can temporarily stop reproduction of the information in which an index including data of addresses that indicate the positions of paragraphs in the information is inserted at the beginning of the information, automatically, at a position desired by the user or distributor of the information.

According to the present invention (Claim 7), in the information distribution/reproduction system defined in Claim 6, when the information is work information, the index is inserted between a procedure along which the user of the information actually performs the work, and a procedure along which a working apparatus automatically performs the work for a predetermined period of time when the user of the information operates the working apparatus. Therefore, the system can provide the index by which the information distribution apparatus or the information reproduction apparatus can send the information to the working apparatus according to the working speed of the working apparatus.

According to the present invention (Claim 8), in the information distribution/reproduction system defined in Claim 1 or 2, when the information is work information, the contents of a work corresponding to each of plural blocks into which the information is divided by the indexes are recorded as characters in a position where reproduction of the information is to be temporarily stopped at any of the indexes. Therefore, the system can provide the user of the information with an image by which he/she can confirm the contents of the invention, for every index.

According to the present invention (Claim 9), in the information distribution/reproduction system defined in Claim 8, when reproduction of the information is temporarily stopped at the index, an image in which the contents of a work corresponding to each of plural blocks into which the information is divided by the indexes are recorded as characters, is displayed. Therefore, the user of the information can confirm the contents of the information for every index.

According to the present invention (Claim 10), in the information distribution/reproduction system defined in Claim 7, it is detected by a start-of-work detection means that the working apparatus for performing the work on the basis of the information starts the work. Therefore, the information reproduction apparatus can send the information to the working apparatus according to the working speed of the working apparatus.

According to the present invention (Claim 11), in the information distribution/reproduction system defined in Claim 10, the time required for the work is stored in each index by a work time storage means; the information between the indexes is stored as a block by a work block storage means; the remaining time of the time required for the work, in which the working apparatus automatically performs the work for a predetermined period of time, is counted by a timer means; and a work procedure is determined by a work procedure optimization means so that the time required for the work is minimized, according to a total time storage means, the work block storage means, and the timer means. Therefore, the worker can complete plural works to be performed simultaneously, within the shortest time.

According to the present invention (Claim 12), in the information distribution/reproduction system defined in Claim 11, at least one of the times stored in the work time storage means is changed by a work time change means. Therefore, the worker can complete plural works to be performed simultaneously, within the shortest time according to his/her capability.

According to the present invention (Claim 13), in the information distribution/reproduction system defined in Claim 11, the time during which the working apparatus automatically performs the work for a predetermined period is counted by a time counting means from a point of time when distribution of the information, which has been temporarily stopped by the information reproduction control means, is resumed; and a work procedure is determined by the work procedure optimization means so that the time required for the subsequent work becomes shortest, by comparing the remaining work time, the time required for the work to be performed by the worker in the future, and the time required for the work to be performed by the working apparatus. Therefore, even when reproduction of the information is temporarily stopped due to the index, plural works to be performed simultaneously can be completed within the shortest time.

According to the present invention (Claim 14), in the information distribution/reproduction system defined in Claim 13, the information is information for performing cooking; the work the worker actually performs is a work such as cutting, forming, stirring, mixing, or the like during the cooking; and the work the working apparatus automatically performs is a work such as cooling, heating, or the like. Therefore, even when the information in which indexes are inserted is one for performing cooking, reproduction of the information can be temporarily stopped at a position desired by the user or distributor of the information, and it can be resumed at a point of time when the need for resuming reproduction of the information comes about.

According to the present invention (Claim 15), there is provided an information distribution method for distributing information such as a moving picture, a still picture, a sound, characters, or the like, wherein information in which indexes indicating paragraphs of the information are inserted is distributed. Therefore, it is possible to provide an information distribution method to be used for an information distribution/reproduction system that can temporarily stop reproduction of the information automatically at a position desired by the user or distributor of the information.

According to the present invention (Claim 16), in the information distribution method as defined in Claim 15, information in which the indexes are not inserted is distributed. Therefore, it is possible to provide an information distribution method to be used for an information distribution/reproduction system which can reproduce even the information of the conventional format, in which no indexes are inserted.

According to the present invention (Claim 17), in the information distribution method defined in Claim 16, an information reproduction apparatus, which reproduces the information that includes the indexes and is distributed from an information distribution apparatus, is specified by an information reproduction apparatus specifying means; even when distribution of the information from the distribution apparatus is interrupted, the information is redistributed by a resume means to the information reproduction apparatus to which the information has been distributed; and accounting information according to the information is formed by an accounting information formation means. Therefore, it is possible to provide an information distribution method to be used for an information distribution/reproduction system which can distribute the information to a specified information reproduction apparatus, and calculate the usage charge for the information.

According to the present invention (Claim 18), in the information distribution method defined in Claim 17, an index including data of addresses that indicate the positions of paragraphs in the information, which index is inserted at the beginning of the information, is detected by an index address detection means; the detected index is stored in an index address storage means; and when the information reaches any of the addresses, a detection signal is outputted by the index address detection means, and the index is inserted and recorded in the address. Therefore, it is possible to provide an information distribution method to be used for an information distribution/reproduction system which can temporarily stop reproduction of the information in which an index including data of addresses that indicate the positions of paragraphs in the information is inserted at the beginning of the information, automatically, at a position desired by the user or distributor of the information.

According to the present invention (Claim 19), in the information distribution method defined in Claim 18, the time required for the work is stored in each index by a work time storage means; the information between the indexes is stored as a block by a work block storage means; the remaining time of the time required for the work, in which the working apparatus automatically performs the work for a predetermined period of time, is counted by a timer means; and a work procedure is determined by a work procedure optimization means so that the time required for the work is minimized, according to a total time storage means, the work block storage means, and the timer means. Therefore, it is possible to provide an information distribution method to be used for an information distribution/reproduction system which can complete plural works to be performed simultaneously, within the shortest time.

According to the present invention (Claim 20), in the information distribution method defined in Claim 19, at least one of the times stored in the work time storage means is changed by a work time change means. Therefore, it is possible to provide an information distribution method to be used for an information distribution/reproduction system which can complete plural works to be performed simultaneously, within the shortest time according to the capability of the worker.

According to the present invention (Claim 21), in the information distribution method defined in Claim 20, the time during which the working apparatus automatically performs the work for a predetermined period is counted by a time counting means from a point of time when distribution of the information which has been temporarily stopped by the information reproduction control means is resumed; and a work procedure is determined by the work procedure optimization means so that the time required for the subsequent work is minimized, by comparing the remaining work time, the time required for the work to be performed by the worker in the future, and the time required for the work to be performed by the working apparatus. Therefore, it is possible to provide an information distribution method to be used for an information distribution/reproduction apparatus which can complete plural works to be performed simultaneously, within the shortest time, even when reproduction of the information is temporarily stopped due to the index.

According to the present invention (Claim 22), there is provided an information reproduction method for distributing and reproducing information such as a moving picture, a still picture, a sound, characters, or the like, wherein information in which indexes indicating paragraphs of the information are inserted is reproduced. Therefore, it is possible to provide an information reproduction method to be used for an information distribution/reproduction system that can temporarily stop reproduction of the information automatically at a position desired by the user or distributor of the information.

According to the present invention (Claim 23), in the information reproduction method defined in Claim 22, each index is detected by an index detection means; either a mode of temporarily stopping the reproduction of the information at the detected index or a mode of continuing the reproduction is selected by a mode selection means; and whether the reproduction of the information should be temporarily stopped or continued is controlled by an information reproduction control means, on the basis of the results obtained by the index detection means and the mode selection means. Therefore, it is possible to provide an information reproduction method to be used for an information distribution/reproduction system that can temporarily stop reproduction of the information automatically at a position desired by the user or distributor of the information.

According to the present invention (Claim 24), in the information reproduction method defined in Claim 23, an instruction for resuming reproduction of the information, which reproduction is being temporarily stopped on the basis of the results obtained by the index detection means and the mode selection means, is distributed to an information distribution apparatus which distributes the information in which the indexes are inserted. Therefore, it is possible to provide an information reproduction method to be used for an information distribution/reproduction system that can resume reproduction of the information, which has temporarily been stopped at a position desired by the user or distributor of the information.

According to the present invention (Claim 25), in the information reproduction method defined in Claim 23, information in which the indexes are not inserted is reproduced. Therefore, it is possible to provide an information reproduction method to be used for an information distribution/reproduction system which can reproduce even the information of the conventional format, in which no indexes are inserted.

According to the present invention (Claim 26), in the information reproduction method defined in Claim 25, an information reproduction apparatus, which reproduces the information that includes the indexes and is distributed from the information distribution apparatus, is specified by an information reproduction apparatus specifying means; even when distribution of the information from the distribution apparatus is interrupted, the information is redistributed by a resume means to the information reproduction apparatus to which the information has been distributed; and accounting information according to the information is formed by an accounting information formation means. Therefore, it is possible to provide an information reproduction method to be used for an information distribution/reproduction system which can distribute the information to a specified information reproduction apparatus, and calculate the usage charge for the information.

According to the present invention (Claim 27), in the information reproduction method defined in Claim 21, an index including data of addresses that indicate the positions of paragraphs in the information, which index is inserted at the beginning of the information, is detected by an index address detection means; the detected index is stored in an index address storage means; and when the information reaches any of the addresses, a detection signal is outputted by the index address detection means, and the index is inserted and recorded in the address. Therefore, it is possible to provide an information reproduction method to be used for an information distribution/reproduction system which can temporarily stop reproduction of the information in which an index including data of addresses that indicate the positions of paragraphs in the information is inserted at the beginning of the information, automatically, at a position desired by the user or distributor of the information.

According to the present invention (Claim 28), in the information reproduction method defined in Claim 23, the information is work information, and an index display means displays an image in which the contents of a work corresponding to each of plural blocks into which the information is divided at the indexes are recorded as characters, when reproduction of the information is temporarily stopped due to the index. Therefore, it is possible to provide an information reproduction method to be used for an information distribution/reproduction system with which the user of the information can confirm the contents of the information for every index.

According to the present invention (Claim 29), in the information reproduction method defined in Claim 27, it is detected by a work start detection means that the working apparatus for performing a work on the basis of the information starts the work. Therefore, it is possible to provide an information reproduction method to be used for an information distribution/reproduction system in which the information reproduction apparatus can send the information to the working apparatus according to the working speed of the working apparatus.

According to the present invention (Claim 30), in the information reproduction method defined in Claim 29, the time required for the work is stored in each index by a work time storage means; the information between the indexes is stored as a block in a work block storage means; the remaining time of the time required for the work, in which the working apparatus automatically performs the work for a predetermined period of time,. is counted by a timer means; and a work procedure is determined by a work procedure optimization means so that the time required for the work is minimized, according to a total time storage means, the work block storage means, and the timer means. Therefore, it is possible to provide an information reproduction method to be used for an information distribution/reproduction apparatus which can complete plural works to be performed simultaneously, within the shortest time.

According to the present invention (Claim 31), in the information reproduction method defined in Claim 30, at least one of the times stored in the work time storage means is changed by a work time change means. Therefore, it is possible to provide an information reproduction method to be used for an information distribution/reproduction system which can complete plural works to be performed simultaneously, within the shortest time according to the capability of the worker.

According to the present invention (Claim 32), in the information reproduction method defined in Claim 31, the time during which the working apparatus automatically performs the work for a predetermined period is counted by a time counting means from a point of time when distribution of the information, which has been temporarily stopped by the information reproduction control means, is resumed; and a work procedure is determined by the work procedure optimization means so that the time required for the subsequent working is minimized, by comparing the remaining work time, the time required for the work to be performed by the worker in the future, and the time required for the work to be performed by the working apparatus. Therefore, it is possible to provide an information reproduction method to be used for an information distribution/reproduction apparatus which can complete plural works to be performed simultaneously, within the shortest time, even when reproduction of the information is temporarily stopped due to the index.

According to the present invention (Claim 33), there is provided an information recording method for recording information such as a moving picture, a still picture, a sound, characters, or the like, wherein information in which indexes indicating paragraphs of the information are inserted is recorded together with the indexes on a recording medium by an information recording/reproduction means, or the information recorded on the recording medium is reproduced; each index is detected by an index detection means; either a mode of temporarily stopping the reproduction of the information at the detected index or a mode of continuing the reproduction is selected by a mode selection means; and whether the reproduction of the information should be temporarily stopped or continued is controlled by an information reproduction control means, on the basis of the results obtained by the index detection means and the mode selection means. Therefore, it is possible to provide an information recording method to be used for an information distribution/reproduction system which can temporarily stop reproduction of the information recorded on the recording medium, automatically, at a position desired by the user or distributor of the information.

According to the present invention (Claim 34), in the information recording method defined in Claim 33, the index is detected by the index address detection means; the detected index is stored in an index address storage means; and when the information reaches any of addresses included in the index, a detection signal is outputted by an index address detection means, and the index is inserted and recorded in the address. Therefore, it is possible to provide an information recording method to be used for an information distribution/reproduction system which can temporarily stop reproduction of the information in which an index including data of addresses that indicate the positions of paragraphs in the information is inserted at the beginning of the information, automatically, at a position desired by the user or distributor of the information.

According to the present invention (Claim 35), there is provided an information distribution apparatus for distributing information such as a moving picture, a still picture, a sound, characters, or the like, wherein information in which indexes indicating paragraphs of the information are inserted is distributed. Therefore, it is possible to provide an information distribution apparatus constituting a part of an information distribution/reproduction system that can temporarily stop reproduction of the information automatically at a position desired by the user or distributor of the information.

According to the present invention (Claim 36), in the information distribution apparatus defined in Claim 35, information in which the indexes are not inserted is distributed. Therefore, it is possible to provide an information reproduction apparatus constituting a part of an information distribution/reproduction system that can reproduce even the information of the conventional format, in which no indexes are inserted.

According to the present invention (Claim 37), in the information distribution apparatus defined in Claim 36, an information reproduction apparatus, which reproduces the information that includes the indexes and is distributed from the information distribution apparatus, is specified by an information reproduction apparatus specifying means; even when distribution of the information from the distribution apparatus is interrupted, the information is redistributed by a resume means to the information reproduction apparatus to which the information has been distributed; and accounting information according to the information is formed by an accounting information formation means. Therefore, it is possible to provide an information distribution apparatus constituting a part of an information distribution/reproduction system that can distribute the information to a specified information reproduction apparatus, and calculate the usage charge for the information.

According to the present invention (Claim 38), in the information distribution apparatus defined in Claim 37, an index including data of addresses that indicate the positions of paragraphs in the information, which index is inserted at the beginning of the information, is detected by the index address detection means; the detected index is stored in an index address storage means; and when the information reaches any of the addresses, a detection signal is outputted by the index address detection means, and the index is inserted and recorded in the address. Therefore, it is possible to provide an information distribution apparatus constituting a part of an information distribution/reproduction system that can temporarily stop reproduction of the information in which an index including data of addresses that indicate the positions of paragraphs in the information is inserted at the beginning of the information, automatically, at a position desired by the user or distributor of the information.

According to the present invention (Claim 39), in the information distribution apparatus defined in Claim 38, the time required for the work is stored in each index by a work time storage means; the information between the indexes is stored as a block in a work block storage means; the remaining time of the time required for the work, in which the working apparatus automatically performs the work for a predetermined period of time, is counted by a timer means; and a work procedure is determined by a work procedure optimization means so that the time required for the work is minimized, according to a total time storage means, the work block storage means, and the timer means. Therefore, it is possible to provide an information distribution apparatus constituting a part of an information distribution/reproduction system that can complete plural works to be performed simultaneously, within the shortest time.

According to the present invention (Claim 40), in the information distribution apparatus defined in Claim 39, at least one of the times stored in the work time storage means is changed by a work time change means. Therefore, it is possible to provide an information distribution apparatus constituting a part of an information distribution/reproduction system that can complete plural works to be performed simultaneously, within the shortest time according to the capability of the worker.

According to the present invention (Claim 41), in the information distribution apparatus defined in Claim 40, the time during which the working apparatus automatically performs the work for a predetermined period is counted by a time counting means from a point of time when distribution of the information which has been temporarily stopped by the information reproduction control means is resumed; and a work procedure is determined by the work procedure optimization means so that the time required for the subsequent work is minimized, by comparing the remaining work time, the,time required for the work to be performed by the worker in the future, and the time required for the work to be performed by the working apparatus. Therefore, it is possible to provide an information distribution apparatus constituting a part of an information distribution/reproduction apparatus that can complete plural works to be performed simultaneously, within the shortest time, even when reproduction of the information is temporarily stopped due to the index.

According to the present invention (Claim 42), there is provided an information reproduction apparatus for distributing and reproducing information such as a moving picture, a still picture, a sound, characters, or the like, wherein information in which indexes indicating paragraphs of the information are inserted, is reproduced. Therefore, it is possible to provide an information reproduction apparatus constituting a part of an information distribution/reproduction system that can temporarily stop reproduction of the information automatically at a position desired by the user or distributor of the information.

According to the present invention (Claim 43), in the information reproduction apparatus defined in Claim 42, each index is detected by an index detection means; either a mode of temporarily stopping the reproduction of the information at the detected index or a mode of continuing the reproduction is selected by a mode selection means; and whether the reproduction of the information should be temporarily stopped or continued is controlled by an information reproduction control means, on the basis of the results obtained by the index detection means and the mode selection means. Therefore, it is possible to provide an information reproduction apparatus constituting a part of an information distribution/reproduction system that can temporarily stop reproduction of the information automatically at a position desired by the user or distributor of the information.

According to the present invention (Claim 44), in the information reproduction apparatus defined in Claim 43, an instruction for resuming reproduction of the information, which reproduction is being temporarily stopped on the basis of the results obtained by the index detection means and the mode selection means, is distributed to an information distribution apparatus which distributes the information in which the indexes are inserted. Therefore, it is possible to provide an information reproduction apparatus constituting a part of an information distribution/reproduction system that can resume reproduction of the information, which has temporarily been stopped at a position desired by the user or distributor of the information.

According to the present invention (Claim 45), in the information reproduction apparatus defined in Claim 43, information in which the indexes are not inserted is reproduced. Therefore, it is possible to provide an information reproduction apparatus constituting a part of an information distribution/reproduction system that can reproduce even the information of the conventional format, in which no indexes are inserted.

According to the present invention (Claim 46), in the information reproduction apparatus defined in Claim 45, an information reproduction apparatus, which reproduces the information that includes the indexes and is distributed from the information distribution apparatus, is specified by an information reproduction apparatus specifying means; even when distribution of the information from the distribution apparatus is interrupted, the information is redistributed by a resume means to the information reproduction apparatus to which the information has been distributed; and accounting information according to the information is formed by an accounting information formation means. Therefore, it is possible to provide an information reproduction apparatus constituting a part of an information distribution/reproduction system that can distribute the information to a specified information reproduction apparatus, and calculate the usage charge for the information.

According to the present invention (Claim 47), in the information reproduction apparatus defined in Claim 43, an index including data of addresses that indicate the positions of paragraphs in the information, which index is inserted at the beginning of the information, is detected by an index address detection means; the detected index is stored in an index address storage means; and when the information reaches any of the addresses, a detection signal is outputted by the index address detection means, and the index is inserted and recorded in the address. Therefore, it is possible to provide an information reproduction apparatus constituting a part of an information distribution/reproduction system that can temporarily stop reproduction of the information in which an index including data of addresses that indicate the positions of paragraphs in the information is inserted at the beginning of the information, automatically, at a position desired by the user or distributor of the information.

According to the present invention (Claim 48), in the information reproduction apparatus defined in Claim 43, the information is work information, and an index display means displays an image in which the contents of a work corresponding to each of plural blocks into which the information is divided at the indexes are recorded as characters, when reproduction of the information is temporarily stopped due to the index. Therefore, it is possible to provide an information reproduction apparatus constituting a part of an information distribution/reproduction system with which the user of the information can confirm the contents of the information for every index.

According to the present invention (Claim 49), in the information reproduction apparatus defined in Claim 47, it is detected by a work start detection means that the working apparatus for performing a work on the basis of the information starts the work. Therefore, it is possible to provide an information reproduction apparatus constituting a part of an information distribution/reproduction system in which the information reproduction apparatus can send the information to the working apparatus according to the working speed of the working apparatus.

According to the present invention (Claim 50), in the information reproduction apparatus defined in Claim 49, the time required for the work is stored in each index by a work time storage means; the information between the indexes is stored as a block in a work block storage means; the remaining time of the time required for the work, in which the working apparatus automatically performs the work for a predetermined period of time, is counted by a timer means; and a work procedure is determined by a work procedure optimization means so that the time required for the work is minimized, according to a total time storage means, the work block storage means, and the timer means. Therefore, it is possible to provide an information reproduction apparatus constituting a part of an information distribution/reproduction system that can complete plural works to be performed simultaneously, within the shortest time.

According to the present invention (Claim 51), in the information reproduction apparatus defined in Claim 50, at least one of the times stored in the work time storage means is changed by a work time change means. Therefore, it is possible to provide an information reproduction apparatus constituting a part of an information distribution/reproduction system that can complete plural works to be performed simultaneously, within the shortest time according to the capability of the worker.

According to the present invention (Claim 52), in the information reproduction apparatus defined in Claim 51, the time during which the working apparatus automatically performs the work for a predetermined period is counted by a time counting means from a point of time when distribution of the information which has been temporarily stopped by the information reproduction control means is resumed; and a work procedure is determined by the work procedure optimization means so that the time required for the subsequent work is minimized, by comparing the remaining work time, the time required for the work to be performed by the worker in the future, and the time required for the work to be performed by the working apparatus. Therefore, it is possible to provide an information reproduction apparatus constituting a part of an information distribution/reproduction apparatus that can complete plural works to be performed simultaneously, within the shortest time, even when reproduction of the information is temporarily stopped due to the index.

According to the present invention (Claim 53), there is provided an information recording apparatus for recording information such as a moving picture, a still picture, a sound, characters, or the like, wherein information in which indexes indicating paragraphs of the information are inserted is recorded together with the indexes on a recording medium by an information recording/reproduction means, and the information recorded on the recording medium is reproduced; each index is detected by an index detection means; either a mode of temporarily stopping the reproduction of the information at the detected index or a mode of continuing the reproduction is selected by a mode selection means; and whether the reproduction of the information should be temporarily stopped or continued is controlled by an information reproduction control means, on the basis of the results obtained by the index detection means and the mode selection means. Therefore, it is possible to provide an information recording apparatus constituting a part of an information distribution/reproduction system that can temporarily stop reproduction of the information recorded on the recording medium, automatically, at a position desired by the user or distributor of the information.

According to the present invention (Claim 54), in the information recording apparatus defined in Claim 53, the index is detected by the index address detection means; the detected index is stored in an index address storage means; and when the information reaches any of index addresses, a detection signal is outputted by an index address detection means, and the index is inserted and recorded in the address. Therefore, it is possible to provide an information recording apparatus constituting a part of an information distribution/reproduction system that can temporarily stop reproduction of the information in which an index including data of addresses that indicate the positions of paragraphs in the information is inserted at the beginning of the information, automatically, at a position desired by the user or distributor of the information.

According to the present invention (Claim 55), there is provided an information recording medium in which information such as a moving picture, a still picture, a sound, characters, or the like is recorded, wherein information in which indexes indicating paragraphs of the information are inserted is recorded together with the indexes. Therefore, it is possible to provide an information recording medium constituting a part of an information distribution/reproduction system that can temporarily stop reproduction of the information automatically at a position desired by the user or distributor of the information.

According to the present invention (Claim 56), there is provided a working apparatus for performing a work on the basis of information such as a moving picture, a still picture, a sound, characters or the like, wherein an information reproduction apparatus is informed that the working apparatus starts a work on the basis of the information. Therefore, it is possible to provide a working apparatus to be used for an information distribution system in which the information reproduction apparatus can send the information to the working apparatus according to the working speed of the working apparatus.

### BRIEF DESCRIPTION OF THE DRAWINGS

FIG. 1 is a block diagram illustrating an information distribution/reproduction system according to a first embodiment.

FIG. 2 is a diagram illustrating a format of information including indexes according to the first embodiment.

FIG. 3 is a block diagram illustrating an information distribution/reproduction system according to a second embodiment.

FIG. 4 is a block diagram illustrating an information distribution/reproduction system according to a third embodiment.

FIG. 5 is a diagram illustrating a format of information including addresses according to the third embodiment.

FIG. 6 is a block diagram illustrating an information distribution/reproduction system according to a fourth embodiment.

FIG. 7 is a block diagram illustrating an information distribution/reproduction system according to a fifth embodiment.

FIG. 8 is a block diagram illustrating the conventional information distribution/reproduction system.

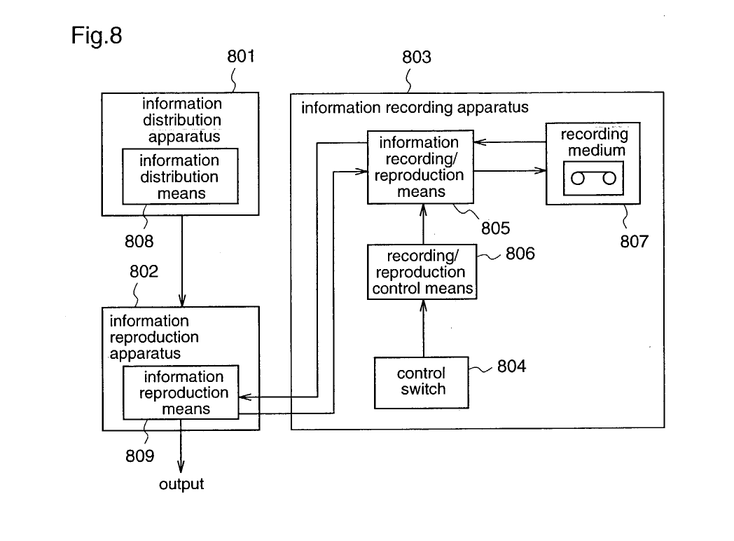

### BEST MODE TO EXECUTE THE INVENTION

(Embodiment 1)

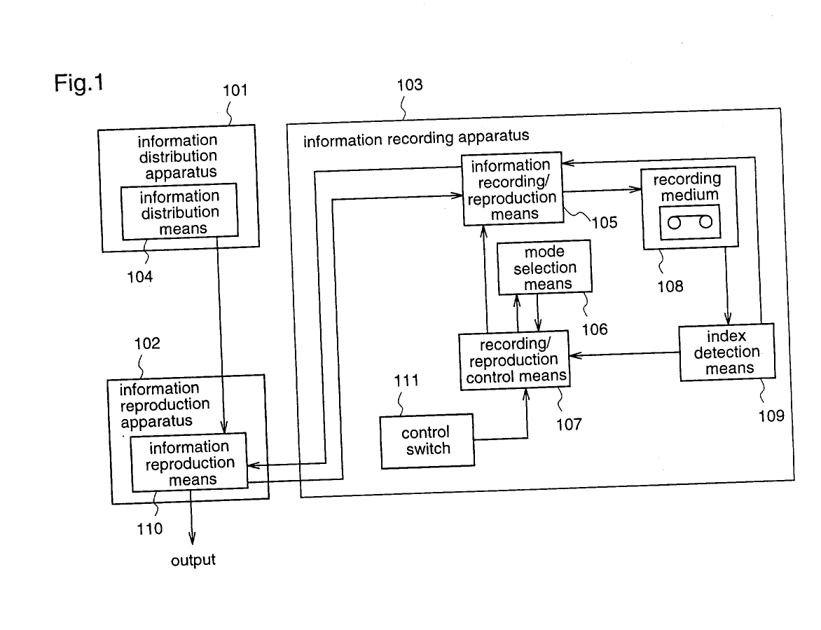

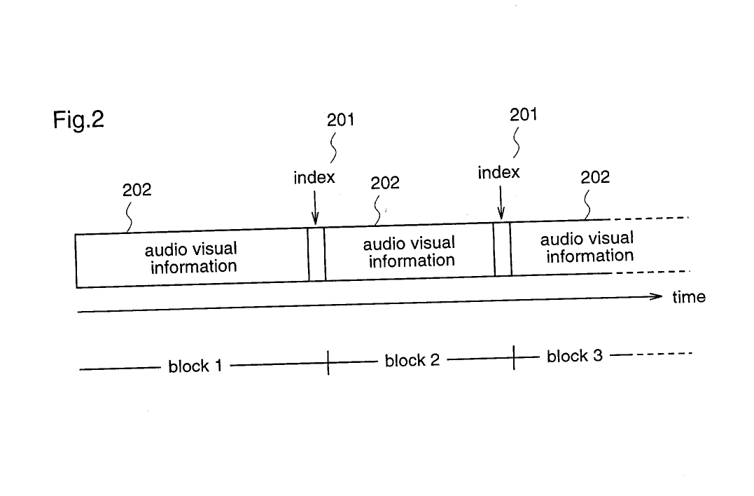

Hereinafter, an information distribution/reproduction system according to a first embodiment will be described with reference to FIG. 1 or 2.

FIG. 1 is a block diagram illustrating an information distribution/reproduction system according to the first embodiment, and FIG. 2 is a diagram illustrating a format of information to be distributed by a distribution apparatus which is a component of the information distribution/reproduction system.

In FIG. 1, reference numeral 101 denotes an information distribution apparatus, 102 denotes an information reproduction apparatus, 103 denotes an information recording apparatus, 104 denotes an information distribution means, 105 denotes an information recording/reproduction means, 106 denotes a mode selection means, 107 denotes a recording/reproduction control means, 108 denotes a recording medium, 109 denotes an index detection means, 110 denotes an information reproduction means, and 111 denotes an operation switch. Further, in FIG. 2, reference numeral 201 denotes an index, and 202 denotes audio visual information.

As shown in FIG. 2, information distributed from the information distribution apparatus 101 such as a broadcast station is divided into plural blocks, and an index is inserted between adjacent blocks. Any format of information may be employed as long as the positions of boundaries of the divided blocks can be specified. Further, methods of inserting indexes are as follows: a method of inserting images indicating indexes in desired frames of information comprising about 30 frames per second, which information is included in a general television broadcast at present;. a method of inserting indexes in a portion of a video signal, which portion is not actually displayed on screen, or in an audio signal; and a method of inserting indexes in a frequency band of a signal recorded on an information medium, which frequency band is not used for video and audio. Further, as for digital television broadcasting that is presently proceeding toward practical use, there is a method of inserting indexes directly as information in broadcast data because the broadcast data is digital data.

Next, the practical operation will be described.

The user of information reproduces the information including the above-mentioned indexes, which is distributed from the information distribution apparatus 101 such as a broadcast station, by the information reproduction apparatus 102 such as a television.

When a recording command is outputted by the operation switch 111, the reproduced information is inputted to the information recording apparatus 103 for recording and reproducing the information, such as a VTR, wherein the information is subjected to signal frequency band conversion so that it can be recorded on the recording medium 108 such as a tape by the information recording/reproduction means 105, and then recorded on the medium 108 together with the indexes. At this time, the placement of the indexes inserted in the recorded information is identical to the placement of the indexes in the information distributed from the information distribution apparatus 101.

Further, the user of information operates the operation switch 111 to select either a mode of temporarily stopping the information at an index or a mode of continuously reproducing the information by using the recording/reproduction control means 107, and stores the result of the mode selection in the mode selection means 106. The operation switch 111 comprises individual switches to be operated by the user of information, such as switches for mode selection, reproduction of information, pause, stop, and the like, or combinations of these switches.

Using the operation switch 111 of the information reproduction apparatus, reproduction of the information recorded on the recording medium 108 is started, and an index is detected by the index detection means 109. The detected index is transmitted to the information recording/reproduction means 105 and, simultaneously, the index detection result is transmitted to the recording/reproduction control means 107. The recording/reproduction control means 107 determines as to whether reproduction of information should be temporarily stopped at the index or continued, on the basis of the result of index detection and the result of mode selection which is stored in the mode selection means 106. Then, the information recording/reproduction means 105 continues or temporarily stops reproduction of information according to the result of selection by the recording/reproduction control means 107.

When reproduction is temporarily stopped, the user of information presses the operation switch 111 to resume reproduction of information from the information reproduction apparatus 102, and the information distributed from the recording apparatus 103 is again inputted to the information reproduction apparatus 102 to be reproduced by the information reproduction means 110.

Furthermore, even information including no indexes can be reproduced from the information reproduction apparatus by using the conventional method.

As described above, according to the first embodiment of the invention, since the indexes are inserted in the information, reproduction of information can be automatically stopped at any position desired by the user of information, and it can be resumed at a point of time when the user needs to resume reproduction.

Furthermore, as the information recording apparatus, besides the VRT, various kinds of audio visual recording/reproduction apparatuses, such as a PVR (personal video recorder) utilizing an HDD, may be employed.

Moreover, by distributing information using an exchangeable medium on which indexes are previously recorded, the information can be reproduced using a playback-only apparatus such as a DVD-Video player, a Video CD player, a laser disk player, or the like.

( Embodiment 2)

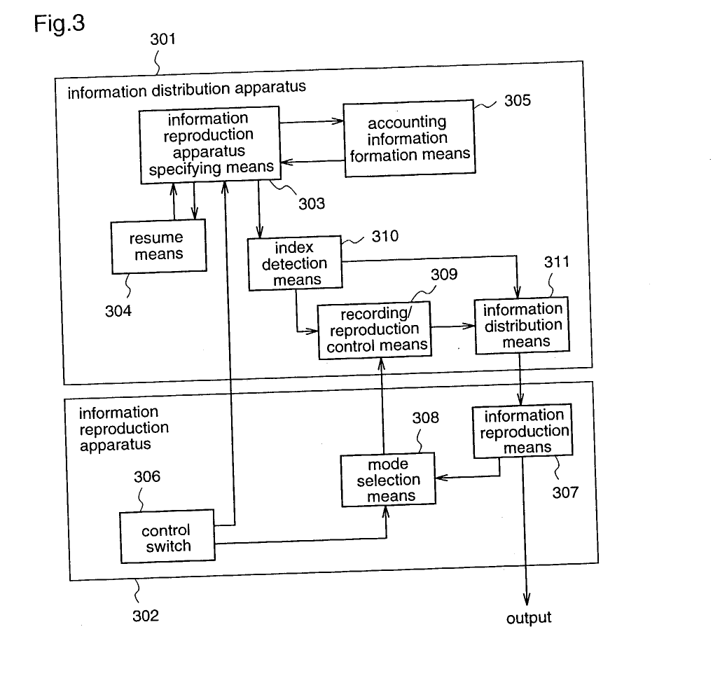

Hereinafter, an information distribution/reproduction system according to a second embodiment of the invention will be described with reference to FIG. 3.

FIG. 3 is a block diagram illustrating an information distribution/reproduction apparatus according to the second embodiment.

In FIG. 3, reference numeral 301 denotes an information distribution apparatus, 302 denotes an information reproduction apparatus, 303 denotes an information reproduction apparatus specifying means, 304 denotes a resume means, 305 denotes an accounting information formation means, 306 denotes an operation switch, 307 denotes an information reproduction means, 308 denotes a mode selection means, 309 denotes a recording/reproduction control means, 310 denotes an index detection means, and 311 denotes an information distribution means.

Next, the operation will be described.

The user of information operates the operation switch 306 to make the information distribution apparatus 301 such as a broadcast station distribute a program table that is possessed by the apparatus 301, through a bidirectional communication medium such as the high-speed internet, to the information reproduction apparatus 302.

The user of information selects a favorite program from the distributed program table, and sends a reproduction start command to the information distribution apparatus 301 by using the operation switch 306. In the information distribution apparatus 301, the information reproduction apparatus specifying means 303 specifies the destination of the selected program, on the basis of information such as an IP address of the information reproduction apparatus 302 on the internet, and the index detection means 310 detects an index which is inserted in the information and indicates a paragraph of the information, and the information distribution means 311 distributes the detected index to the information reproduction apparatus 302 through the bidirectional communication medium. The user of information can send a command such as “temporal stop”, “resumption of reproduction”, “backward reproduction”, or “skip of reproduction” at any time to the information distribution apparatus 301 by operating the operation switch 306. Further, the user can form accounting information according to the distributed information as the need arises, by using the accounting information formation means 305.

Furthermore, the user of information selects either a mode of temporarily stopping reproduction at the position of the detected index or a mode of continuing reproduction, using the mode selection means 308, by operating the operation switch 306, and the selected mode is transmitted to the information distribution apparatus 301 through the bidirectional communication medium. In the information distribution apparatus 301, the recording/reproduction control means 309 controls as to whether distribution of information should be temporarily stopped at the index or continued, on the basis of the detection result of the index inserted in the program which is the above-mentioned information, and the selection result of the mode transmitted from the information reproduction apparatus. When reproduction of information is temporarily stopped, the user of information presses the operation switch 306 to resume distribution of information by the information distribution means 311 of the information distribution apparatus 301.

Even when the information reproduction apparatus 302 stops distribution of information due to power failure during information distribution, turn-off of power by the user of information, or deterioration of the communication status of the bidirectional communication medium, the resume means 304 resumes distribution of information from the status at the point of time when distribution of information was stopped, when the information reproduction apparatus specifying means 303 confirms reconnection of the same information reproduction apparatus 302, from the address of the information that is currently being distributed, which address is always stored in the information distribution apparatus 301, or from the status information such as “during temporal stop” or “during reproduction”.

As described above, according to the second embodiment, since the indexes are inserted in the information, reproduction of the information can be temporarily stopped automatically at a position desired by the user of information, and reproduction of the information can be resumed at a point of time when the user needs to resume reproduction.

Further, when the indexes are not transmitted to the information reproduction apparatus, recording or copying of the information including the indexes can be prevented.

Furthermore, when the information reproduction apparatus of the user of information is specified and stored, the information distribution apparatus can distribute information according to the needs of the user, and it can redistribute the information to the same information reproduction apparatus even when distribution of the information from the distribution apparatus is interrupted.

Furthermore, when accounting information is formed according to the use status of information by the user, the charge for information can be calculated.

Moreover, while in this second embodiment the bidirectional communication medium is a single communication medium such as the high-speed internet, this second embodiment can be executed with plural one-way communication mediums, a combination of a high-speed one-way communication medium and a relatively low-speed one-way or bidirectional communication medium for transmitting apparatus operating information of the user, or a combination of plural bidirectional communication mediums.

(Embodiment 3)

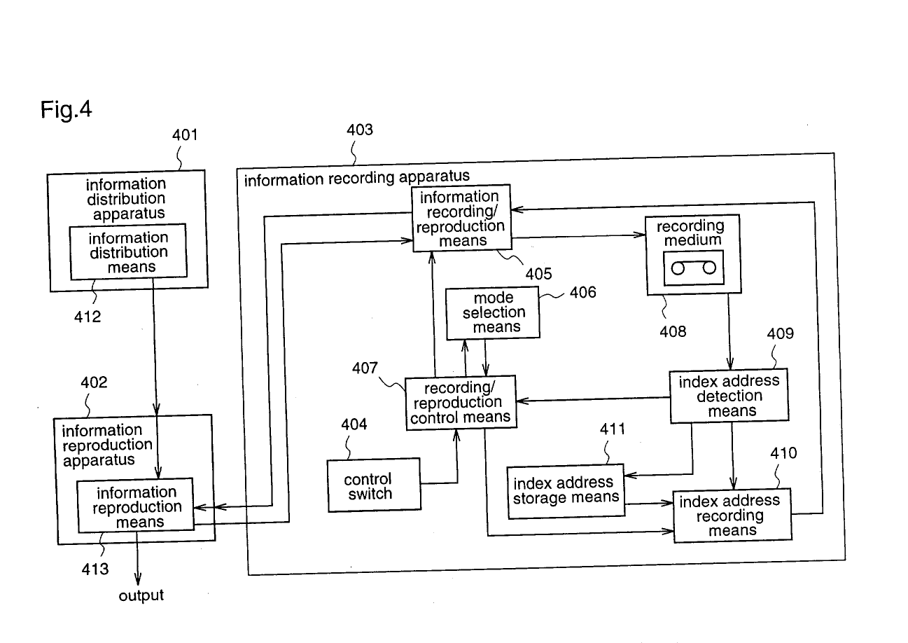

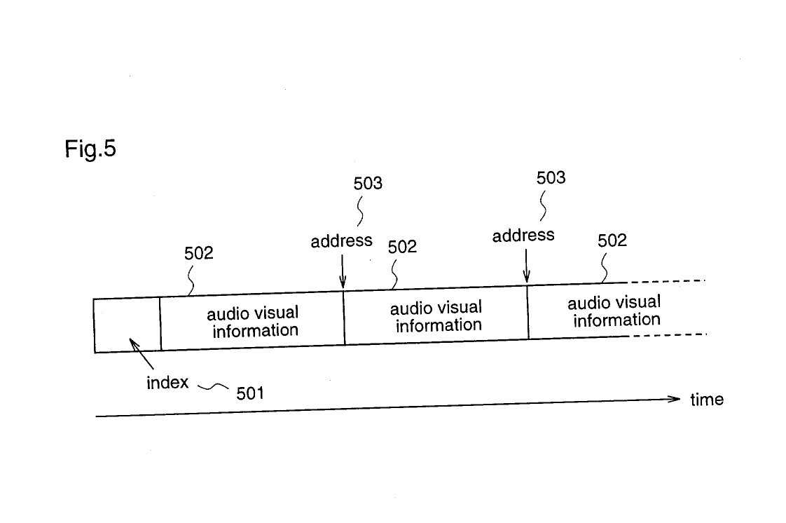

Hereinafter, an information distribution/reproduction system according to a third embodiment will be described with reference to FIG. 4 or 5.

FIG. 4 is a block diagram illustrating an information distribution/reproduction system according to the third embodiment, and FIG. 5 is a diagram illustrating a format of information to be distributed by an information distribution apparatus which is a component of the information distribution/reproduction system.

In FIG. 4, reference numeral 401 denotes an information distribution apparatus, 402 denotes an information reproduction apparatus, 403 denotes an information recording apparatus, 404 denotes an operation switch, 405 denotes an information recording/reproduction means, 406 denotes a mode selection means, 407 denotes a recording/reproduction control means, 408 denotes a recording medium, 409 denotes an index address detection means, 410 denotes an index address recording means, 411 denotes an index address storage means, 412 denotes an information distribution means, and 413 denotes an information reproduction means. Further, in FIG. 5, reference numeral 501 denotes an index, 502 denotes audio visual information, and 503 denotes an address.

As shown in FIG. 5, in the information to be distributed from the information distribution apparatus 401 such as a broadcast station, an index which includes data of addresses indicating the positions of paragraphs in the information, is inserted at the beginning of the information.

Next, the operation will be described.

The information distribution apparatus 401 distributes the above-mentioned information to the information reproduction apparatus 402 through the information distribution means 412.

The information is transmitted from the information reproduction apparatus 402 to the information recording/reproduction means 405 of the information recording apparatus 403, and recorded on the recording medium 408. Then, the information is reproduced from the recording medium 408 by the operation switch 404, the index at the beginning of the information is detected by the index address detection means 409, and the addresses included in the information are successively extracted and stored in the index address storage means 411. When the information which is being sequentially reproduced reaches the stored address, the index address recording means 410 inserts (records) the index in the address according to a command from the recording/reproduction control means 407. Thereby, the index at the beginning of the information is dispersed into desired positions of the addresses in the information, and the information becomes to have the same format as the format of the information according to the first embodiment. Thereafter, reproduction of the information will be carried out in the same manner as described for the first embodiment.

As described above, according to the third embodiment, even when reproducing information having a format in which addresses indicating the locations of indexes in the information being distributed are inserted, reproduction of the information can be temporarily stopped automatically at a position desired by the user of the information, and further, reproduction of the information can be resumed at a point of time when the need for resuming reproduction arises.

In this third embodiment, information which is distributed in a format wherein an index is recorded at the beginning of the information is converted into a format where the index is directly inserted in addresses corresponding to desired positions in the information. However, the inverse of this conversion or conversion from another format into a recording format suited to the recording medium can also be carried out.

(Embodiment 4)

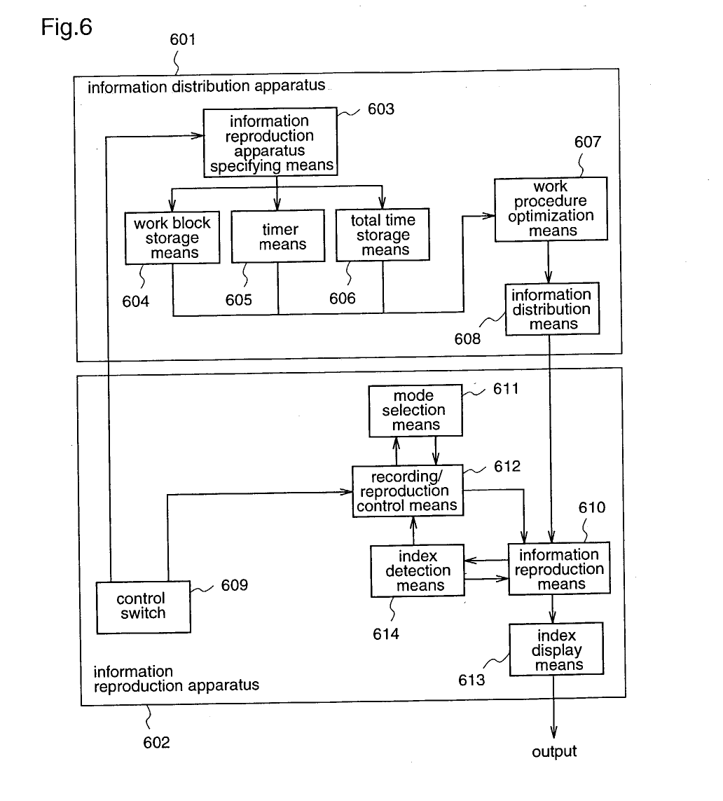

Hereinafter, a fourth embodiment of the present invention will be described with reference to FIG. 6.

FIG. 6 is a block diagram illustrating an information distribution/reproduction system according to the fourth embodiment.

In FIG. 6, reference numeral 601 denotes an information distribution apparatus, 602 denotes an information reproduction apparatus, 603 denotes an information reproduction apparatus specifying means, 604 denotes a work block storage means, 605 denotes a timer means, 606 denotes a total time storage means, 607 denotes a work procedure optimization means, 608 denotes an information distribution means, 609 denotes an operation switch, 610 denotes an information reproduction means, 611 denotes a mode selection means, 612 denotes a recording/reproduction control means, 613 denotes an index display means, and 614 denotes an index detection means.

A description will be now given of an example of simultaneously cooking three kinds of dishes, i.e., beef curry, boiled rice, and potato salad. The procedures for cooking these dishes are as follows.

(Work Procedure for Cooking Beef Curry)

1-(a) Peel potatoes, carrots, and onions, and cut them into desired sizes.

1-(b) Cut beef into desired sizes.

1-(c) Heat oil in a pan, and fry the potato, carrot, onion, and beef.

1-(d) Put water in the pan, and boil for about 30 minutes.

1-(e) Add curry roux, stir well, and boil for more 10 minutes.

(Work Procedure for Cooking Boiled Rice)

2-(a) Measure a desired amount of rice, and wash it.

2-(b) Put the rice and an appropriate amount of water in a rice cooker, and cook it.

(Work Procedure for Cooking Potato Salad)

3-(a) Wash potatoes with the skins well.

3-(b) Put water in a pan, and add a little salt.

3-(c) Boil the potatoes with the skins for about 30 minutes.

3-(d) Put water in another pan, and add a little salt.

3-(e) Put raw eggs in the pan, heat the pan over a fire, and bring the water to the boil while changing the position of the pan sometimes.

3-(f) Boil the eggs for about ten minutes.

3-(g) Put the boiled potatoes in a basket.

3-(h) Peel the skins while the potatoes are hot.

3-(i) Mash the potatoes with a masher.

3-(j) Cool the boiled eggs with running water while the eggs are hot.

3-(k) Peel the boiled eggs immediately.

3-(l) Cut the peeled boiled eggs into small pieces.

3-(m) Put the mashed potato and the boiled egg together, and cool them.

3-(n) Cut cucumbers into thin slices.

3-(o) Shake a little salt over the sliced cucumber, and squeeze the cucumber to remove the excessive water.

3-(p) Put the cucumber and the cooled potato and boiled egg together.

3-(q) Cool them in a refrigerator for about 2 hours.

3-(r) Add salt, pepper, and mayonnaise to taste, and mix well.

It is assumed that data of the above-mentioned work procedures are included in the information distributed from the information distribution apparatus 601, and the work procedures are divided into plural blocks as follows, and further, indexes are inserted among the respective blocks.

(Work Procedure for Cooking Beef Curry)

Block 1-1

1-(a) Peel potatoes, carrots, and onions, and cut them into desired sizes.

1-(b) Cut beef into desired sizes.

1-(c) Heat oil in a pan, and fry the potato, carrot, onion, and beef.

1-(d) Put water in the pan, and boil for about 30 minutes.

Block 1-2

1-(e) Add curry roux, stir well, and boil for more 10 minutes.

(Work Procedure for Cooking Boiled Rice)

Block 2-1

2-(a) Measure a desired amount of rice, and wash it.

2-(b) Put the rice and an appropriate amount of water in a rice cooker, and cook it.

(Work Procedure for Cooking Potato Salad)

Block 3-1

3-(a) Wash potatoes with the skins well.

3-(b) Put water in a pan, and add a little salt.

3-(c) Boil the potatoes with the skins for about 30 minutes.

Block 3-2

3-(d) Put water in another pan, and add a little salt.

3-(e) Put raw eggs in the pan, heat the pan over a fire, and bring the water to the boil while changing the position of the pan sometimes.

3-(f) Boil the eggs for about ten minutes.

Block 3-3

3-(g) Put the boiled potatoes in a basket.

3-(h) Peel the skins while the potatoes are hot.

3-(i) Mash the potatoes with a masher.

Block 3-4

3-(j) Cool the boiled eggs with running water while the eggs are hot.

3-(k) Peel the boiled eggs immediately.

3-(l) Cut the boiled and peeled eggs into small pieces.

3-(m) Put the mashed potato and the boiled egg together, and cool them.

Block 3-5

3-(n) Cut cucumbers into thin slices.

3-(o) Shake a little salt over the sliced cucumber, and squeeze the cucumber to remove the excessive water.

Block 3-6

3-(p) Put the cucumber and the cooled potato and boiled egg together.

3-(q) Cool them in a refrigerator for about 2 hours.

Block 3-7

3-(r) Add salt, pepper, and mayonnaise to taste, and mix well.

Each index inserted between the adjacent blocks of each cooking includes, as data, the sum of the standard work time of each block and the time required for displaying characters which briefly describe the work of the corresponding block as an image (hereinafter referred to as “work time”), and the time required for the cooking after ending the work of each block (hereinafter referred to as “process time”). Further, each time data has a table or a calculation formula that changes according the amounts of materials to be cooked, whereby the required time can be calculated according to the amounts of materials. The standard work time and process time of each block are as follows. Further, a numerical expression “n” in the work time or process time indicates the number of servings of each dish to be cooked.

(Work Procedure for Cooking Beef Curry)

Block 1-1

| | |
|---|---|
| work time | 10 min + 5 min × n |
| process time | 30 min |

Block 1-2

| | |
|---|---|
| work time | 3 min |
| process time | 10 min |

(Work Procedure for Cooking Boiled Rice)

Block 2-1

| | |
|---|---|
| work time | 5 min |
| process time | 30 min + 15 min × n |

(Work Procedure for Cooking Potato Salad)

Block 3-1

| | |
|---|---|
| work time | 10 min × n |
| process time | 20 min |

Block 3-2

| | |
|---|---|
| work time | 10 min |
| process time | 10 min |

Block 3-3

| | |
|---|---|
| work time | 10 min + 5 min × n |
| process time | 0 min |

Block 3-4

| | |
|---|---|
| work time | 5 min + 5 min × n |
| process time | 30 min |

Block 3-5

| | |
|---|---|
| work time | 5 min + 5 min × n |
| process time | 0 min |

Block 3-6

| | |
|---|---|
| work time | 2 min |
| process time | 120 min |

Block 3-7

| | |
|---|---|
| work time | 5 min |
| process time | 0 min |

In this fourth embodiment, it is assumed that each dish is prepared for four servings.

The user of information selects the menus and amounts of dishes to be cooked by using the operation switch 609, and the selected data are transmitted through the bidirectional communication medium to the information distribution apparatus 601 such as a broadcast station. In the broadcast station, the standard time required for each work is calculated, and the information reproduction apparatus 602 to which information is to be distributed is specified by the information reproduction apparatus specification means 603. The work time and process time of each block are as follows.

Block 1-1

| | |
|---|---|
| work time | 30 min |
| process time | 30 min |

Block 1-2

| | |
|---|---|
| work time | 3 min |
| process time | 10 min |

Block 2-1

| | |
|---|---|
| work time | 5 min |
| process time | 90 min |

Block 3-1

| | |
|---|---|
| work time | 40 min |
| process time | 20 min |

Block 3-2

| | |
|---|---|
| work time | 10 min |
| process time | 10 min |

Block 3-3

| | |
|---|---|
| work time | 30 min |
| process time | 0 min |

Block 3-4

| | |
|---|---|
| work time | 25 min |
| process time | 30 min |

Block 3-5

| | |
|---|---|
| work time | 25 min |
| process time | 0 min |

Block 3-6

| | |
|---|---|
| work time | 2 min |
| process time | 120 min |

Block 3-7

| | |
|---|---|
| work time | 5 min |
| process time | 0 min |

The information distribution apparatus 601 automatically selects a most efficient work order on the basis of the work times and process times.

Although various algorithms for optimizing the work order can be thought of, cooking of a menu having the longest work time remaining is selected with priority in this fourth embodiment. Further, the work order may be selected using other algorithms than described for this embodiment.

The information distribution apparatus 601 is provided with the work block storage means 604 for holding the completed work blocks of each work; the timer means 605 for counting the remaining process time of the material being cooked; and the total time storage means 606 for holding the sum of the remaining work time and process time of each work. The value to be stored in the total time storage means 606 is calculated from the work times and process times of the respective blocks of each work. In the case of the above-described work, it is 73 minutes for the beef curry, 95 minutes for the boiled rice, and 317 minutes for the potato salad. Then, the work procedure optimization means 607 determines a work order along which the work can be done with the highest efficiency, on the basis of the above-described results.

The information reproduction apparatus 602 may have the above-mentioned means to select the most-efficient work order. Since the potato salad has the longest remaining time of 317 minutes, cooking should be started with the potato salad.

Initially, the information distribution apparatus 601 distributes information indicating the work procedure of the block 3-1 which has been stored in advance. The information distribution apparatus 601 reproduces the information of the block 3-1, and detects an index at the end of the block 3-1 to temporarily stop the distribution of the information. At this time, the information distribution apparatus 601 distributes, as the above-mentioned index, a still picture of video information including characters that briefly describe the contents of the work of the block 3-1, or the information distribution apparatus 601 temporarily stops distribution of the information itself although it distributes the video information including characters that briefly describe the contents of the work of the block 301 just before the temporary stop, whereby the brief description between the blocks is displayed as characters on the information reproduction apparatus 602. Alternatively, the video information just before the temporary stop, which is stored in the information reproduction apparatus 602, is displayed during the temporary stop.

The worker who performs cooking with reference to the information checks the contents of the work which is displayed, and then performs the work practically. When the worker has done the work and starts the subsequent process, the worker operates the operation switch 609 to transmit a reproduction resume command to the information distribution apparatus 601, whereby the information distribution apparatus 601 starts distribution of the next work information. Simultaneously, the timer means 605 starts count-down from 20 minutes that is the process time of the work.

Although the standard work time of the block 3-1 whose work information is distributed is 40 minutes, if the actual work time is different from it, the work procedure along which the work can be efficiently carried out according to the current work proceeding status is re-evaluated every time the process is started after completion of the work and the reproduction start command is transmitted to the information distribution apparatus 601 by the operation switch 609.

Next, the information distribution apparatus 601 selects the work of the block 2-1 having the longest work time stored in the total time storage means 606, from among the block 1-1, block 2-1, and block 3-2 which are steps to be performed next, of the above-mentioned three kinds of cooking.

Thereafter, the above-described work is repeated on the basis of the successively distributed information until the three kinds of cooking are all done.

While in this fourth embodiment the three kinds of works are carried out simultaneously, the user can complete more works with efficiency in the shortest time by proceeding the works while checking the audio visual data of the work information which is successively transmitted from the broadcast station.

Further, while in this fourth embodiment cooking is described as the contents of work, the present invention is applicable to various kinds of works, such as fabrication of products or education of a processing work, so long as it is a work including information that notifies the user of a procedure along which the working apparatus proceeds the work even when the user does not operate the apparatus for a predetermined period of time after the user has once operated the apparatus, or a procedure which includes a step of leaving the apparatus for a predetermined period of time or until another work has completed.

Furthermore, since the information between the indexes is displayed as characters or an image during temporary stop of information distribution, the user can check the contents of the information at all times. By performing this step until the last block in the work information, the user can reliably carry out the work while checking the procedure and proceeding method of the work.

Moreover, the information between the indexes can be displayed as characters or an image during temporary stop of information distribution, even on a reproduction-only apparatus, such as a writable/readable VTR, a DVD-Video player for playback only, or a laser disk drive.

Furthermore, the above-mentioned processing can also be performed by a PVR (Personal Video Recorder) utilizing an HDD as a recording medium, as a system which can perform recording and reproduction simultaneously. In this case, the above-mentioned information can be recorded simultaneously with temporary stop of the information during distribution or reproduction with time delay, and therefore, it is not necessary to temporarily record all of the information.

Moreover, when the information distribution apparatus is provided with a work time change means with which the worker can change at least one time information in the work procedure decided by the work procedure optimization means, the information distribution apparatus can select a work procedure suited to the capability of the worker.

(Embodiment 5)

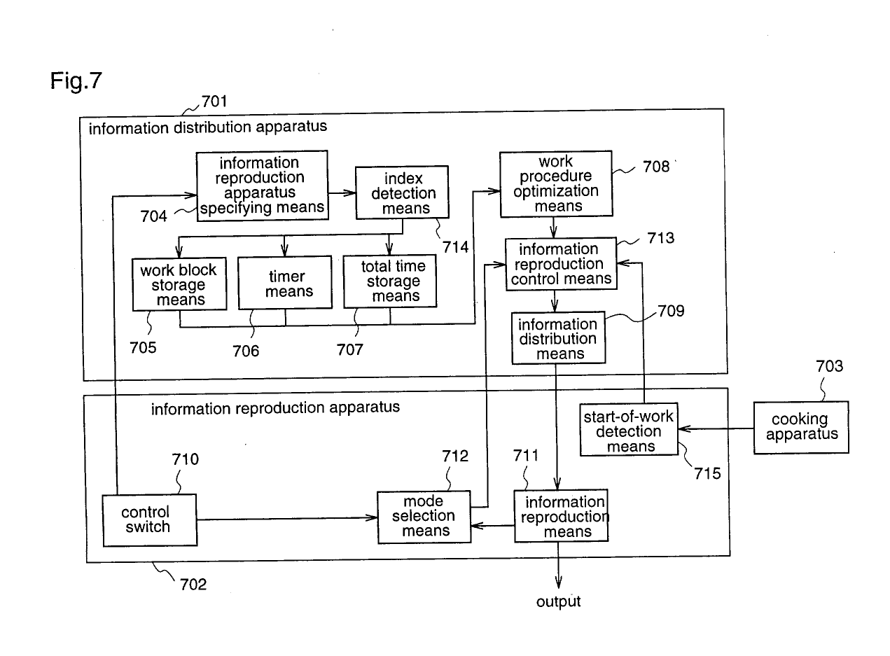

Next, a fifth embodiment of the present invention will be described with reference to FIG. 7.

FIG. 7 is a block diagram illustrating an information distribution/reproduction system according to a fifth embodiment of the present invention.

In FIG. 7, reference numeral 701 denotes an information distribution apparatus, 702 denotes an information reproduction apparatus, 703 denotes a cooking apparatus, 704 denotes an information reproduction apparatus specification means, 705 denotes a work block storage means, 706 denotes a timer means, 707 denotes a total time storage means, 708 denotes a working order optimization means, 709 denotes an information distribution means, 710 denotes an operation switch, 711 denotes an information reproduction means, 712 denotes a mode selection means, 713 denotes an information reproduction control means, 714 denotes an index detection means, and 715 denotes a working start detection means.

Next, the operation will be described.

In this fifth embodiment, it is assumed that the above-mentioned “information” explains a work procedure of cooking, and the above-mentioned “index” divides the information for every work block. Further, when the information is work information, the contents of a work in the corresponding block are recorded as characters in a position at which reproduction is temporarily stopped by the index.

Further, the contents of works to be practically performed by the worker are cutting, forming, stirring, mixing, and the like during cooking, and the contents of works to be performed by the cooking apparatus 703 are cooling, heating, and the like.

The information distribution apparatus 701 such as a broadcast station has library data of cooking information, and the worker as the user of information operates the operation switch 710 to display the library data on the information reproduction apparatus 702. This operation is informed to the information distribution apparatus 701 through the bidirectional communication medium, and the information distribution apparatus 701 identifies the information reproduction apparatus 702 as an information reproduction apparatus to which the information should be distributed, and distributes the information to the apparatus 702.

The worker selects required data from the displayed library data and transmits a reproduction start command to the information distribution apparatus 701 by operating the operation switch 710, and the information distribution apparatus 701 distributes the requested data through the bidirectional communication medium. When the worker requires “temporary stop”, “resumption of reproduction”, “backward reproduction”, “skip of reproduction” or the like, the worker sends a command to the information distribution apparatus 701 by using the operation switch 710, whereby the worker can obtain his/her favorite result of reproduction.

When the worker performs mode selection as to whether distribution should be temporarily stopped at the position of the index information, by using the operation switch 710, the selected mode is transmitted to the information distribution apparatus 701 through the bidirectional communication medium.

Then, the information distribution apparatus 701 selects either temporarily stopping distribution of the information at the index or continuously reproducing the information, on the basis of the detection result of the index in the information as well as the mode selected by the user. In the information, the work procedure is optimized as described for the fourth embodiment.

When the mode of temporarily stopping reproduction of the information at the index is selected, the information distribution apparatus 701 temporarily stops the information at the index. While the information is being temporarily stopped, any of the following images is displayed: a static image of the proceeding information screen; an image which is obtained by converting the video information between the indexes into characters that briefly describe the work procedure of cooking as the above-described information; an image in which text data indicating characters that briefly describe the work procedure of cooking between the indexes is superimposed on a static image of the proceeding information screen; and an image of the text data only.

The worker carries out the cooking according to the instruction of the information, and puts the materials in the cooking apparatus 703 such as a microwave oven, a gas range, a refrigerator or the like, which is the above-described working apparatus. When the worker presses a cooking start switch of the cooking apparatus 703, the cooking apparatus 703 automatically starts cooking and, simultaneously, sends a command to the information reproduction apparatus 702. Then, the information reproduction apparatus 702 detects the command signal with the working start detection means 715, and transmits a command for resuming reproduction of the program which is currently being stopped, to the information distribution apparatus 701 through the bidirectional communication medium. Then, the continuation of the information indicating the cooking procedure is automatically distributed from the information distribution apparatus 701, and reproduced by the information reproduction apparatus 702. The information reproduction apparatus 702 may reproduce the information which has previously been distributed from the information distribution apparatus 701.

Further, the index may include cooking work data of plural kinds of cooking apparatuses. For example, when the cooking apparatus 703 is a microwave oven, the information distribution apparatus 701 transmits information about the output power at cooking, cooking time, and the like. When the cooking apparatus 703 is a gas range, the information distribution apparatus 701 transmits information about the extent of fire, the heating time, and the like. Also in this case, the worker puts the materials which have been processed as required, in the cooking apparatus 703, and presses the cooking start switch of the cooking apparatus 703, whereby the cooking apparatus 703 automatically starts cooking and sends a signal to the information reproduction apparatus 702. Then, the information reproduction apparatus 702 detects the signal with the working start detection means 715 and transmits it to the information distribution apparatus 701. Whereby, the information distribution apparatus 701 automatically distributes the continuation of the information indicating the cooking procedure, and the information is reproduced by the information reproduction apparatus 702.

As described above, according to the fifth embodiment, when performing plural works at the same time, even if distribution of information is temporarily stopped, the times required for the respective works are compared again to complete all of the works within the shortest work time.

Furthermore, the working apparatus can automatically perform a work and reproduce information along the work, by simply being supplied with an instruction to start the work from the user who presses the operation switch.

Applicability in Industory

Information including indexes and distributed from a broadcast station or the like is reproduced by an information reproduction apparatus such as a television apparatus, and the reproduced information is recorded, together with the indexes, on an information recording apparatus for recording information and reproducing it, such as a VTR, a personal video recorder (PVR), a video CD or DVD-video recording/reproduction apparatus, and the indexes are detected by the information reproduction apparatus, whereby reproduction of the information can be automatically stopped or resumed at a position desired by the distributor or user of the information.

1. An information distribution/reproduction system for distributing and reproducing information such as a moving picture, a still picture, a sound, characters, or the like, wherein
information in which indexes indicating paragraphs of the information are inserted is distributed;
each index is detected by an index detection means;
either a mode of temporarily stopping reproduction of the information at the detected index or a mode of continuing reproduction is selected by a mode selection means; and
whether reproduction of the information should be temporarily stopped or continued is controlled by an information reproduction control means, on the basis of the results obtained by the index detection means and the mode selection means.

2. An information distribution/reproduction system for distributing and reproducing information such as a moving picture, a still picture, a sound, characters, or the like, wherein
information in which indexes indicating paragraphs of the information are inserted is distributed;
the information including the indexes is temporarily recorded on a recording medium by an information recording/reproduction means, and the information recorded on the recording medium is reproduced;
each index is detected by an index detection means;
either a mode of temporarily stopping reproduction of the information at a detected index or a mode of continuing reproduction is selected by a mode selection means; and
whether reproduction of the information recorded on the recording medium should be temporarily stopped or continued is controlled by an information reproduction control means, on the basis of the results obtained by the index detection means and the mode selection means.

3. An information distribution/reproduction system as defined in claim 1, wherein
an instruction for resuming reproduction of the information, which reproduction is being temporarily stopped on the basis of the results obtained by the index detection means and the mode selection means, is transmitted to an information distribution apparatus which has distributed the information in which the indexes are inserted.

4. An information distribution/reproduction system as defined in claim 1 or 2, wherein
information in which the indexes are not inserted is distributed, and the information is reproduced.

5. An information distribution/reproduction system as defined in claim 4, wherein
an information reproduction apparatus, which reproduces the information that includes the indexes and is distributed from the information distribution apparatus, is specified by an information reproduction apparatus specifying means;
even when distribution of the information from the distribution apparatus is interrupted, the information is redistributed by a resume means to the information reproduction apparatus to which the information has been distributed; and
accounting information according to the information is formed by an accounting information formation means.

6. An information distribution/reproduction system as defined in claim 1 or 2, wherein
information, in which an index including data of addresses that indicate the positions of paragraphs in the information is inserted at the beginning of the information, is distributed;
the index is detected by the index address detection means;
the detected index is stored in an index address storage means; and
when the information reaches any of the addresses, a detection signal is outputted by the index address detection means, and the index is inserted and recorded in the address.

7. An information distribution/reproduction system as defined in claim 6, wherein
when the information is work information, the index is inserted between a procedure along which the user of the information actually performs the work, and a procedure along which a working apparatus automatically performs the work for a predetermined period of time when the user of the information operates the working apparatus.

8. An information distribution/reproduction system as defined in claim 1 or 2, wherein
when the information is work information, the contents of a work corresponding to each of plural blocks into which the information is divided by the indexes are recorded as characters in a position where reproduction of the information is to be temporarily stopped at any of the indexes.

9. An information distribution/reproduction system as defined in claim 8, wherein
when reproduction of the information is temporarily stopped at the index, an image in which the contents of a work corresponding to each of plural blocks into which the information is divided by the indexes are recorded as characters, is displayed.

10. An information distribution/reproduction system as defined in claim 7, wherein
it is detected by a start-of-work detection means that the working apparatus for performing the work on the basis of the information starts the work.

11. An information distribution/reproduction system as defined in claim 10, wherein
the time required for the work is stored in each index by a work time storage means;
the information between the indexes is stored as a block by a work block storage means;
the remaining time of the time required for the work, in which the working apparatus automatically performs the work for a predetermined period of time, is counted by a timer means; and
a work procedure is determined by a work procedure optimization means so that the time required for the work is minimized, according to a total time storage means, the work block storage means, and the timer means.

12. An information distribution/reproduction system as defined in claim 11, wherein
at least one of the times stored in the work time storage means is changed by a work time change means.

13. An information distribution/reproduction system as defined in claim 11, wherein
the time during which the working apparatus automatically performs the work for a predetermined period is counted by a time counting means from a point of time when distribution of the information, which has been temporarily stopped by the information reproduction control means, is resumed; and
a work procedure is determined by the work procedure optimization means so that the time required for the subsequent work becomes shortest, by comparing the remaining work time, the time required for the work to be performed by the worker in the future, and the time required for the work to be performed by the working apparatus.

14. An information distribution/reproduction system as defined in claim 13, wherein
the information is information for performing cooking;
the work the worker actually performs is a work such as cutting, forming, stirring, mixing, or the like during the cooking; and
the work the working apparatus automatically performs is a work such as cooling, heating, or the like.

15. An information distribution method for distributing information such as a moving picture, a still picture, a sound, characters, or the like, wherein
information in which indexes indicating paragraphs of the information are inserted is distributed.

16. An information distribution method as defined in claim 15, wherein information in which the indexes are not inserted is distributed.

17. An information distribution method as defined in claim 16, wherein
an information reproduction apparatus, which reproduces the information that includes the indexes and is distributed from an information distribution apparatus, is specified by an information reproduction apparatus specifying means;
even when distribution of the information from the distribution apparatus is interrupted, the information is redistributed by a resume means to the information reproduction apparatus to which the information has been distributed; and
accounting information according to the information is formed by an accounting information formation means.

18. An information distribution method as defined in claim 17, wherein
an index including data of addresses that indicate the positions of paragraphs in the information, which index is inserted at the beginning of the information, is detected by an index address detection means;
the detected index is stored in an index address storage means; and
when the information reaches any of the addresses, a detection signal is outputted by the index address detection means, and the index is inserted and recorded in the address.

19. An information distribution method as defined in claim 18, wherein
the time required for the work is stored in each index by a work time storage means;
the information between the indexes is stored as a block by a work block storage means;
the remaining time of the time required for the work, in which the working apparatus automatically performs the work for a predetermined period of time, is counted by a timer means; and
a work procedure is determined by a work procedure optimization means so that the time required for the work is minimized, according to a total time storage means, the work block storage means, and the timer means.

20. An information distribution method as defined in claim 19, wherein
at least one of the times stored in the work time storage means is changed by a work time change means.

21. An information distribution method as defined in claim 20, wherein
the time during which the working apparatus automatically performs the work for a predetermined period is counted by a time counting means from a point of time when distribution of the information which has been temporarily stopped by the information reproduction control means is resumed; and
a work procedure is determined by the work procedure optimization means so that the time required for the subsequent work is minimized, by comparing the remaining work time, the time required for the work to be performed by the worker in the future, and the time required for the work to be performed by the working apparatus.

22. An information reproduction method for distributing and reproducing information such as a moving picture, a still picture, a sound, characters, or the like, wherein
information in which indexes indicating paragraphs of the information are inserted is reproduced.

23. An information reproduction method as defined in claim 22, wherein
each index is detected by an index detection means;
either a mode of temporarily stopping the reproduction of the information at the detected index or a mode of continuing the reproduction is selected by a mode selection means; and
whether the reproduction of the information should be temporarily stopped or continued is controlled by an information reproduction control means, on the basis of the results obtained by the index detection means and the mode selection means.

24. An information reproduction method as defined in claim 23, wherein
an instruction for resuming reproduction of the information, which reproduction is being temporarily stopped on the basis of the results obtained by the index detection means and the mode selection means, is distributed to an information distribution apparatus which distributes the information in which the indexes are inserted.

25. An information reproduction method as defined in claim 23, wherein
information in which the indexes are not inserted is reproduced.

26. An information reproduction method as defined in claim 25, wherein
an information reproduction apparatus, which reproduces the information that includes the indexes and is distributed from the information distribution apparatus, is specified by an information reproduction apparatus specifying means;
even when distribution of the information from the distribution apparatus is interrupted, the information is redistributed by a resume means to the information reproduction apparatus to which the information has been distributed; and
accounting information according to the information is formed by an accounting information formation means.

27. An information reproduction method as defined in claim 21, wherein
an index including data of addresses that indicate the positions of paragraphs in the information, which index is inserted at the beginning of the information, is detected by an index address detection means;
the detected index is stored in an index address storage means; and
when the information reaches any of the addresses, a detection signal is outputted by the index address detection means, and the index is inserted and recorded in the address.

28. An information reproduction method as defined in claim 23, wherein
the information is work information, and an index display means displays an image in which the contents of a work corresponding to each of plural blocks into which the information is divided at the indexes are recorded as characters, when reproduction of the information is temporarily stopped due to the index.

29. An information reproduction method as defined in claim 27, wherein
it is detected by a work start detection means that the working apparatus for performing a work on the basis of the information starts the work.

30. An information reproduction method as defined in claim 29, wherein
the time required for the work is stored in each index by a work time storage means;
the information between the indexes is stored as a block in a work block storage means;
the remaining time of the time required for the work, in which the working apparatus automatically performs the work for a predetermined period of time, is counted by a timer means; and
a work procedure is determined by a work procedure optimization means so that the time required for the work is minimized, according to a total time storage means, the work block storage means, and the timer means.

31. An information reproduction method as defined in claim 30, wherein
at least one of the times stored in the work time storage means is changed by a work time change means.

32. An information reproduction method as defined in claim 31, wherein
the time during which the working apparatus automatically performs the work for a predetermined period is counted by a time counting means from a point of time when distribution of the information, which has been temporarily stopped by the information reproduction control means, is resumed; and
a work procedure is determined by the work procedure optimization means so that the time required for the subsequent work is minimized, by comparing the remaining work time, the time required for the work to be performed by the worker in the future, and the time required for the work to be performed by the working apparatus.

33. An information recording method for recording information such as a moving picture, a still picture, a sound, characters, or the like, wherein
information in which indexes indicating paragraphs of the information are inserted is recorded together with the indexes on a recording medium by an information recording/reproduction means, or the information recorded on the recording medium is reproduced;
each index is detected by an index detection means;
either a mode of temporarily stopping the reproduction of the information at the detected index or a mode of continuing the reproduction is selected by a mode selection means; and
whether the reproduction of the information should be temporarily stopped or continued is controlled by an information reproduction control means, on the basis of the results obtained by the index detection means and the mode selection means.

34. An information recording method as defined in claim 33, wherein
the index is detected by the index address detection means;
the detected index is stored in an index address storage means; and
when the information reaches any of addresses included in the index, a detection signal is outputted by an index address detection means, and the index is inserted and recorded in the address.

35. An information distribution apparatus for distributing information such as a moving picture, a still picture, a sound, characters, or the like, wherein
information in which indexes indicating paragraphs of the information are inserted is distributed.

36. An information distribution apparatus as defined in claim 35, wherein
information in which the indexes are not inserted is distributed.

37. An information distribution apparatus as defined in claim 36, wherein
an information reproduction apparatus, which reproduces the information that includes the indexes and is distributed from the information distribution apparatus, is specified by an information reproduction apparatus specifying means;
even when distribution of the information from the distribution apparatus is interrupted, the information is redistributed by a resume means to the information reproduction apparatus to which the information has been distributed; and
accounting information according to the information is formed by an accounting information formation means.

38. An information distribution apparatus as defined in claim 37, wherein
an index including data of addresses that indicate the positions of paragraphs in the information, which index is inserted at the beginning of the information, is detected by the index address detection means;
the detected index is stored in an index address storage means; and
when the information reaches any of the addresses, a detection signal is outputted by the index address detection means, and the index is inserted and recorded in the address.

39. An information distribution apparatus as defined in claim 38, wherein
the time required for the work is stored in each index by a work time storage means;
the information between the indexes is stored as a block in a work block storage means;
the remaining time of the time required for the work, in which the working apparatus automatically performs the work for a predetermined period of time, is counted by a timer means; and
a work procedure is determined by a work procedure optimization means so that the time required for the work is minimized, according to a total time storage means, the work block storage means, and the timer means.

40. An information distribution apparatus as defined in claim 39, wherein
at least one of the times stored in the work time storage means is changed by a work time change means.

41. An information distribution apparatus as defined in claim 40, wherein
the time during which the working apparatus automatically performs the work for a predetermined period is counted by a time counting means from a point of time when distribution of the information which has been temporarily stopped by the information reproduction control means is resumed; and
a work procedure is determined by the work procedure optimization means so that the time required for the subsequent work is minimized, by comparing the remaining work time, the time required for the work to be performed by the worker in the future, and the time required for the work to be performed by the working apparatus.

42. An information reproduction apparatus for distributing and reproducing information such as a moving picture, a still picture, a sound, characters, or the like, wherein
information in which indexes indicating paragraphs of the information are inserted, is reproduced.

43. An information reproduction apparatus as defined in claim 42, wherein
each index is detected by an index detection means;
either a mode of temporarily stopping the reproduction of the information at the detected index or a mode of continuing the reproduction is selected by a mode selection means; and
whether the reproduction of the information should be temporarily stopped or continued is controlled by an information reproduction control means, on the basis of the results obtained by the index detection means and the mode selection means.

44. An information reproduction apparatus as defined in claim 43, wherein
an instruction for resuming reproduction of the information, which reproduction is being temporarily stopped on the basis of the results obtained by the index detection means and the mode selection means, is distributed to an information distribution apparatus which distributes the information in which the indexes are inserted.

45. An information reproduction apparatus as defined in claim 43, wherein
information in which the indexes are not inserted is reproduced.

46. An information reproduction apparatus as defined in claim 45, wherein
an information reproduction apparatus, which reproduces the information that includes the indexes and is distributed from the information distribution apparatus, is specified by an information reproduction apparatus specifying means;
even when distribution of the information from the distribution apparatus is interrupted, the information is redistributed by a resume means to the information reproduction apparatus to which the information has been distributed; and
accounting information according to the information is formed by an accounting information formation means.

47. An information reproduction apparatus as defined in claim 43, wherein
an index including data of addresses that indicate the positions of paragraphs in the information, which index is inserted at the beginning of the information, is detected by an index address detection means;
the detected index is stored in an index address storage means; and
when the information reaches any of the addresses, a detection signal is outputted by the index address detection means, and the index is inserted and recorded in the address.

48. An information reproduction apparatus as defined in claim 43, wherein
the information is work information, and an index display means displays an image in which the contents of a work corresponding to each of plural blocks into which the information is divided at the indexes are recorded as characters, when reproduction of the information is temporarily stopped due to the index.

49. An information reproduction apparatus as defined in claim 47, wherein
it is detected by a work start detection means that the working apparatus for performing a work on the basis of the information starts the work.

50. An information reproduction apparatus as defined in claim 49, wherein
the time required for the work is stored in each index by a work time storage means;
the information between the indexes is stored as a block in a work block storage means;
the remaining time of the time required for the work, in which the working apparatus automatically performs the work for a predetermined period of time, is counted by a timer means; and
a work procedure is determined by a work procedure optimization means so that the time required for the work is minimized, according to a total time storage means, the work block storage means, and the timer means.

51. An information reproduction apparatus as defined in claim 50, wherein
at least one of the times stored in the work time storage means is changed by a work time change means.

52. An information reproduction apparatus as defined in claim 51, wherein
the time during which the working apparatus automatically performs the work for a predetermined period is counted by a time counting means from a point of time when distribution of the information which has been temporarily stopped by the information reproduction control means is resumed; and
a work procedure is determined by the work procedure optimization means so that the time required for the subsequent work is minimized, by comparing the remaining work time, the time required for the work to be performed by the worker in the future, and the time required for the work to be performed by the working apparatus.

53. An information recording apparatus for recording information such as a moving picture, a still picture, a sound, characters, or the like, wherein
information in which indexes indicating paragraphs of the information are inserted is recorded together with the indexes on a recording medium by an information recording/reproduction means, and the information recorded on the recording medium is reproduced;
each index is detected by an index detection means;
either a mode of temporarily stopping the reproduction of the information at the detected index or a mode of continuing the reproduction is selected by a mode selection means; and
whether the reproduction of the information should be temporarily stopped or continued is controlled by an information reproduction control means, on the basis of the results obtained by the index detection means and the mode selection means.

54. An information recording apparatus as defined in claim 53, wherein
the index is detected by the index address detection means;
the detected index is stored in an index address storage means; and
when the information reaches any of index addresses, a detection signal is outputted by an index address detection means, and the index is inserted and recorded in the address.

55. An information recording medium in which information such as a moving picture, a still picture, a sound, characters, or the like is recorded, wherein
information in which indexes indicating paragraphs of the information are inserted is recorded together with the indexes.

56. A working apparatus for performing a work on the basis of information such as a moving picture, a still picture, a sound, characters or the like, wherein
an information reproduction apparatus is informed that the working apparatus starts a work on the basis of the information.
